(19) United States
(12) Patent Application Publication
(10) Pub. No.: US 2022/0146822 A1
(43) Pub. Date: May 12, 2022

(54) Wearable Display Systems and Design Methods Thereof

(71) Applicant: Ostendo Technologies, Inc., Carlsbad, CA (US)

(72) Inventor: Hussein El-Ghoroury, Carlsbad, CA (US)

(21) Appl. No.: 17/552,332

(22) Filed: Dec. 15, 2021

Related U.S. Application Data
(63) Continuation-in-part of application No. 16/994,574, filed on Aug. 15, 2020, now abandoned.
(60) Provisional application No. 62/887,448, filed on Aug. 15, 2019.

(51) Int. Cl. G02B 27/00; G02B 27/01

(52) U.S. Cl. CPC G02B 27/0093; G02B 27/0101; G02B 2027/0178; G02B 2027/014; G02B 27/0172

(57) ABSTRACT

A wearable display system that includes an optical lens element in optical communication with an electronic display device for displaying images to a viewer. An eye position sensor, head position or pose sensor, and gaze/head pose prediction means are provided. The gaze/head pose prediction means is configured to process a sensed position of the viewer's eyes as one or more observation vectors through a sequentially updated model of the HVS to predict and estimate (multiple frames) the gaze parameters (direction and depth or pose). A host processor is configured to input and output display data, which may comprise light field data, to and from the system to a Cloud processor to provide displayed images to the viewer wherein the displayed images are optimized to match the viewer's human visual system.

### REFERENCE TO RELATED APPLICATIONS

This application claims the benefit of U.S. Provisional Patent Application No.: 62/249,021, filed Aug. 15, 2019, entitled “Wearable Display Systems and Design Methods Thereof”, the entirety of which is incorporated herein by reference, and is a continuation-in-part to U.S. patent application Ser. No.: 16/994,574, filed Aug. 15, 2020, entitled “Wearable Display Systems and Design Methods Thereof”, the entirety of which is incorporated herein by reference.

### BACKGROUND

Almost everyone agrees that wearable near-eye display devices or systems, often referred to as “augmented reality” (AR) displays, are needed to widen or increase the visual information bandwidth accessible to mobile users, in order to extend the global economic growth that the mobile information industry has enabled for the past two-plus decades. Although many are trying to develop such display devices, none have yet succeeded in triggering sought-after mass-market adoption. Obviously there must be a missing technology element. The disclosure herein describes a “technology paradigm shift” that makes near-eye display systems, such as AR displays, truly wearable and thus capable of becoming a ubiquitous mobile device.

Mobile devices such as smartphones are becoming the de-facto primary information connectivity tool for mobile users, making them the main devices for supporting e-commerce and the economic growth it has provided. However, for such economic growth to continue, the information delivery bandwidth of mobile connectivity systems must be increased.

There exists a “last 30-cm gap” problem (the typical viewing distance of a mobile display) with making more visual information available to mobile users. While extremely capable mobile devices exist and very capable networks are in place (and even more powerful ones coming with 5G), coupled with an abundance of rich content accessible across these networks, current mobile display capabilities are limited, first naturally by virtue of their size, and second by the limitations of the legacy mobile displays used in these devices. Because of these limitations, there is a mobile connectivity bottleneck presenting a real obstacle for the continuing growth prospects of mobile digital media end-to-end “bandwidth” and the massive e-commerce industry that has become accustomed to continuing growth.

An intriguing observation is that while using the electron for computation is now reaching its natural throughput limit at the deep nano-scale, at that scale the electron naturally gives up its energy to photons or “light”. This suggests the path to closing the mobile connectivity gap described above is to overlap the roles of the electron and the photon as information is coupled out of the mobile network and through the mobile device by electrons and then coupled visually by photons to the mobile viewer's cognitive perception; ironically by the electron again.

This also suggests that pushing further into the deep nano-scale for gaining computational throughput requires the electrons and photons “seamlessly” share the computational throughput load (burden) for the transfer of information from the network to the mobile viewer's ultimate cognitive perception. The first juncture for such an overlap is a new generation of displays that match the very same overlap that already naturally occurs in how the human visual system (HVS) perceives information, coupled into it by photons, using electrons.

Despite existing technical advancements in mobile information systems, the conversion of electrons (connected data) to photons (visual perceived data) from a mobile display to a mobile user's eye still has several major limitations in maintaining a mobility factor:
1. brightness remains a problem especially for sunlight readability,
2. display resolution, being restricted to 2-dimensions, is generally not enough to couple more information to the eye,
3. there is a limited display area given that mobility constraints handicap an immersive user experience,
4. excessive power consumption of inefficient legacy displays, and,
5. such displays are incapable of enabling a truly “wearable” near-eye display device, which is viewed unanimously as the way to overcome the aforementioned mobile connectivity bottleneck.

Therefore embodiments of the invention provide a wearable near-eye display system and involve design methods that overcome the aforementioned limitations, consequently making “wearable” near-eye display systems realizable and capable of gaining mass-adoption.

The definition of the term “wearable” herein (in terms of the physical constraints it dictates on near-eye display systems) is described in the following detailed description of the wearable display system of embodiments of the invention.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is an illustration of a NEAR Display System Functional Block Diagram.

FIG. 2 is an illustration of a Wearable Display System Physical Configuration Block Diagram.

FIG. 3 is an illustration of a NEAR Personal Area Network (NEAR-PAN) Distributed Computing Environment.

FIGS. 4A and 4B are illustrations of NEAR Display Elements (QPIs) Optically Coupled Directly to the Relay and Magnification Lens.

FIG. 5 is an illustration of a OST-2 NEAR Display.

FIG. 6 is an illustration of a OST-3 NEAR Display.

FIG. 7 is an illustration of a OST-4 NEAR Display.

FIG. 8 is an illustration of a NEAR Display Physical Layout.

FIG. 9 is an illustration of a NEAR Display Early Generation Product (NEAR-EG) Using a QPI Optically Coupled to Lens Edge.

FIG. 10 is an illustration of a NEAR Display Early Generation Product (NEAR-EG OST-1)—QPI Optically Coupled Using Stand-off Assembly.

FIG. 11 is an illustration of Human Visual System Eye and Head Movement Ranges.

FIGS. 12A and 12B are illustrations of a Human Visual System FOV with Eye Optical FOV and Eye Movements.

FIG. 13 is an illustration of a Human Visual System Surround Light Field FOV with Eye, Head, and Body Movements.

FIG. 14 is an illustration of a Human Eye Retina Photo Sensory Capability.

FIG. 15 is an illustration of a HVS Photo Sensory Color Gamut.

FIG. 16 is an illustration of a Classification of HVS Depth Cues.

### DETAILED DESCRIPTION

### LIST OF ACRONYMS

| | |
|---|---|
| API | Application Programming Interface |
| AR | Augmented Reality: a live direct or indirect view of a |
| | physical, real-world environment whose elements are |
| | augmented (or supplemented) by computer-generated |
| | sensory input such as sound, video, graphics or GPS data. |
| ACM | Augmented Cross Modal Perception |
| BT | Bluetooth: a wireless technology standard for exchanging |
| | data over short distances from fixed and mobile devices, |
| | and building personal area networks |
| CE | Consumer Electronics |
| F³ | Form, Fit and Function |
| FOV | Field of View |
| GI | Gesture Interaction |
| GPU | Graphics Processing Unit |
| HUD | Head-Up Display |
| HVS | Human Visual System |
| IMU | Inertial Measurement Unit: an electronic device that |
| | measures and reports a body's specific force, angular rate, |
| | and sometimes the magnetic field surrounding the body, |
| | using a combination of accelerometers and gyroscopes, |
| | sometimes also magnetometers. |
| IP | Intellectual Property |
| IPD | Interpupillary Distance |
| Kbps | Kilo bits-per-second |
| L | Left |
| LF | Light Field |
| LFP | Light Field Processor |
| LiPo | Lithium Polymer battery |
| MAP | Mobile Applications Processor |
| MHL | Mobile High-Definition Link: an industry standard for a |
| | mobile audio/video interface that allows consumers to |
| | connect mobile phones, tablets, and other portable |
| | consumer electronics (CE) devices to high-definition video |
| | and audio sources |
| MIPI | Mobile Industry Processor Interface: interface specifications |
| | for the mobile ecosystem |
| MWAN | Mobile Wide Area Network |
| NEAR | Near Eye Augmented Reality |
| O/S | Operating Systems |
| PAN | Personal Area Network |
| PMIC | Power Management Integrated Circuit |
| R | Right |
| SCIC | Super Capacitor Integrated Circuit |
| SIP | System-in-a-Package |
| SLF | Streaming Light Field |
| SV | Sunlight Viewable |
| TBR | To Be Reviewed |
| TC | Touch Command |
| USB | Universal Serial Bus: an industry standard that defines the |
| | cables, connectors and communications protocols |
| | used in an electrical interface bus for connection, |
| | communication, and power supply between computers and |
| | electronic devices. |
| VC | Voice Command |
| VR | Virtual Reality: a computer technology that replicates an |
| | environment, real or imagined, and simulates a user's |
| | physical presence and environment to allow for user |
| | interaction. Virtual realities artificially create |
| | sensory experience, which can include sight, touch, |
| | hearing, and smell. |
| VS | Visual Select |
| Wi-Fi | Wi-Fi: a technology that allows electronic devices to |
| | connect to a WLAN network |
| WLAN | Wireless Local Area Network |

This disclosure presents functional & interface specifications of a Wearable NEAR Display System within the context of an operating mobile environment, according to embodiments of the invention. Wearability dictates volumetric, weight, stylistic, and power consumption constraints. The disclosure presents design methods for creating a multi-mode AR/VR NEAR Display System that meets such wearability constraints by off-loading the Wearable Display processing element computing burden to the multiple computing nodes of the viewer's mobile environment, i.e., the smartphone and smart watch, plus the Cloud Computing resources operationally associated with the NEAR Display System. Within the Wearable Display element of the NEAR Display System design wearability is achieved, while also achieving desired display resolution, by optically coupling a multiplicity of light modulation elements (QPIs) directly onto the Wearable Display element relay and magnification optical element (the glasses lens). The QPIs compressed input design methods are also used to achieve wearability by alleviating the processing demand of first decompressing the light field input data before modulating it. The QPIs compressed input parameters are adapted dynamically based on predications of the viewer's gaze information, including updated discrete-time estimates of the viewer's HVS neural pathways states based on sensed viewer's eye and head movements plus the eyes iris diameters and IPD. The dynamic adaptation of the QPI light modulation parameters in response to updated discrete-time estimates of the viewer's HVS neural pathways states enables the acquisition of corresponding light field information across the viewer's gaze zone in real-time while matching the HVS acuity limits, i.e., achieving the highest visual experience fidelity. Engaging the viewer's HVS in-the-loop enables a three tiers protocol for the streaming, acquisition, compression and processing of the (high bandwidth) light field information from the Cloud LFP, to the Host LFP in the smartphone then ultimately to the NEAR Display with all three tiers of the NEAR Display System interacting together to efficiently acquire and process (render, adaptation and compression) the light field visual information within the viewer's gaze zone in real-time while matching the HVS acuity limits and minimizing the processing burden at the NEAR Display element to make it wearable. A passive gesture sensor coupled into the viewer's smart watch, making it another processing node of the NEAR Display System, also contributes to alleviating the volumetric, power and processing burdens at the NEAR Display element while adding a reliable (resilient to external interference), and efficient capability of reach gesture repertoire for the viewer to interact with the entire volume of the displayed light field. The NEAR Display System is presented in a business context that describes a product offering strategy that make it possible the NEAR Display System to gain acceptance from the mobile market echo system participants leading to ultimate acceptance of the mobile users.

### 1. Wearable Display System Design

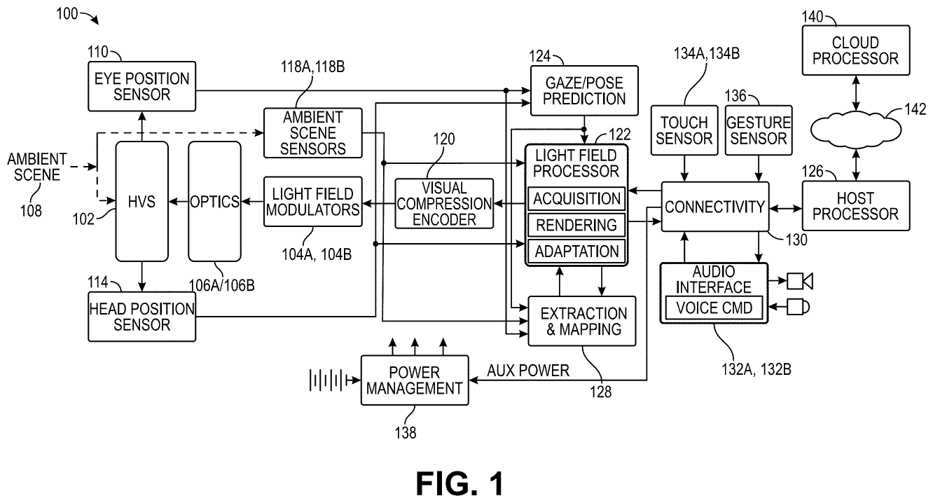

FIG. 1, together with Table 1, illustrate a functional block diagram and design specification of a wearable Near-Eye Augmented Reality (AR) display system 100, herein referred to as “NEAR Display System” 100, according to embodiments of the invention. The following is a high level description of the function and interfaces (internal and external) of the constituent functions of the NEAR Display System 100 of FIG. 1.

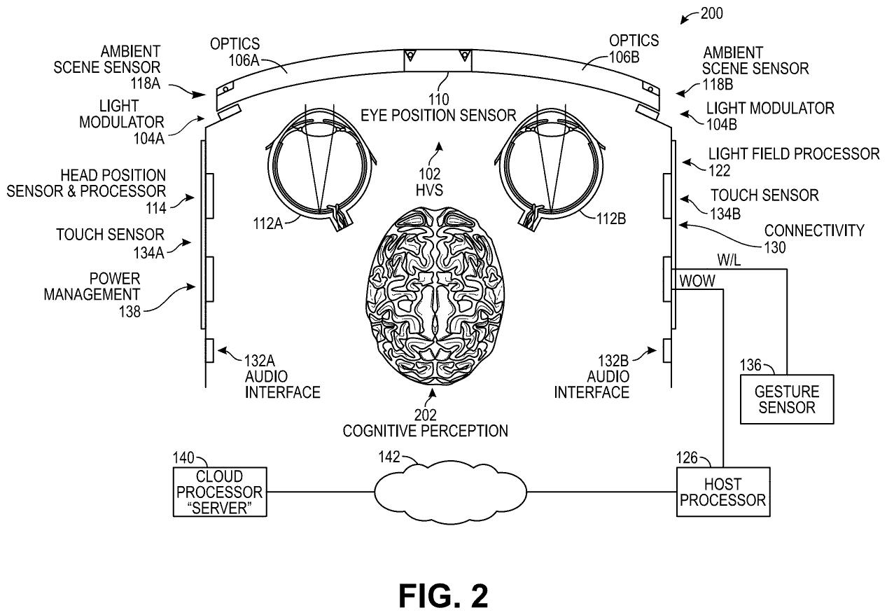

In support of the description of the NEAR Display System 100 functions and interfaces of FIG. 1, FIG. 2 illustrates the system physical configuration 200 with the functional elements put in perspective. One aspect or design strategy of the NEAR Display System 100 according to embodiments of the invention is that it is designed to closely match the human visual system (HVS) 102 and intentionally includes the HVS 102 in-the-loop as depicted in FIG. 1. In that regard, the NEAR Display System 100 modulates light within the HVS visual perception limits, thus not wasting resources in processing information that will not or cannot be perceived by the HVS 102.

Furthermore, the NEAR Display System 100 leverages what the HVS 102 is already capable of rather than duplicating it—thus there is no need for the NEAR Display System 100 to incorporate complex machine vision capabilities since the HVS 102 in-the-loop is already doing the work. This same strategy is followed with the NEAR Display System 100 mobile computing environment in that the NEAR Display System 100 does not needlessly duplicate the capabilities of other elements of its mobile computing environment, instead it leverages such capabilities in order to offload its processing load (or burden) as much as possible in order to maximize its operational specification parameters.

By adopting this strategy, the NEAR Display System 100 is able to meet the above-stated design objectives by “matching and integrating” the HVS 102 in-the-loop as well as by being an integral part of its surrounding mobile computing environment as depicted in FIG. 1.

An integral aspect of this strategy is based on the use of a solid-state emissive micro-scale pixel array, described in, for instance, U.S. Pat. No 7,623,560 entitled “Quantum Photonic Imagers and Methods of Fabrication Thereof”, to realize the light (field) modulators 104A and 104B of FIG. 1, which is referred to herein as the “Quantum Photonic Imager (QPI®)”.

Pursuant to this approach and as discussed below, use of the QPI within the context of the NEAR Display System 100 exemplary functional and interface specifications, constitutes the “missing technology element” that achieves the NEAR Display System 100 design objective of being truly wearable.

Within the context of this disclosure, the term “light field” is used to mean the total geometric extent of the light incident upon and perceived by a viewer of the NEAR display system 100. In that regard, therefore, the term light field may reference both the HVS monocular and binocular perception of the total geometric extent of the light impinging through the optical elements 106A and 106B of the HVS 102; i.e., the NEAR Display System Viewer's eyes. Within the context of this definition, therefore, the term “light field” may also refer to the cognitive perception 202 of the visual information modulated by the NEAR Display System to blend within and augment the ambient light field of the NEAR Display System viewer's surroundings.

Also within the context of this disclosure, the term “see-through” is used to represent the fidelity of blending the visual information modulated by the NEAR Display System 100 within the viewer's ambient light field 108 while maintaining minimal optical distortion to enhance the ability of the viewer's HVS 102 to perceive the ambient light field 108.

Also within the context of this disclosure, the term “wearability” may be used to represent the NEAR Display System's ability to achieve the weight, size (or displacement volume) and typical popularly acceptable style of conventional sunglasses without infringing on aesthetics, personal appearance, social acceptance or physical fatigue or discomfort to its user.

The term “wearability” is also meant to include the term “mobility” which is meant to represent maximum access to information (visual, audio and interactive) with minimum impact to the user's freedom to move which is mainly affected by the mobile device connectivity, available power and charge time.

The following description provides details of embodiments of the invention, with reference to FIGS. 1 and 2, and table 1 which highlights selected specifications for the NEAR Display System according to embodiments of the invention.

TABLE 1
Wearable System High Level Specifications

| | |
|---|---|
| Function | Display virtual images in light field 3D and 2D to a |
| | viewer wearing the NEAR display. |
| Objective | Sunlight viewable, high wearability and mobility, |
| | light weight, low power and streamlined design |
| | that provides high fidelity visual experience to a |
| | mobile user. |
| Configuration | Head worn Near-eye display glasses. |
| Inputs | Light field data representation from an external source |
| | Gesture, touch, voice and visual commands |
| | External embedded controls |
| Outputs | Virtual light field input content blended naturally |
| | onto a viewer’ ambient scene |
| | Control icons |
| Specifications | Weight . . . <80 g |
| | Volume . . . <50 cc |
| | Power . . . <400 mW typical, 800 mW max |
| | Resolution . . . >2M effective pixels per eye |
| | Pixel density . . . >40K pixel/mm², matching HVS |
| | acuity |
| | Brightness . . . >5000 nits, ambient level maintained |
| | below eye-safety limits. |
| | Depth perception . . . Viewer focusable |
| | Field of View, FOV . . . >70° × 30° |
| | See-Through aperture . . . >90% |
| | Operational Modes . . . AR, VR or Stereo vision |
| | (stereoscopic) |

1.1 Eye Position Sensor 110
Function Sensing (detecting) a viewer's eyes parameters: position, pupil diameter, reflections.
Configuration Comprised of an IR light source and detector (imager =pixelated detector array) preferably coupled to the system optics 106A and 106B. System optics 106A and 106B couple the IR light to illuminate the eye (e.g., eyes 112A and 112B) and also couple the eye reflections onto the IR light sensor which generate an image of the pupil of each eye. Eye position sensor 110 output enables measurements that include a viewer's pupils (iris) diameter and (x,y) position in reference to each eye's optical axis plus the viewer's interpupillary distance (IPD), which, when calibrated, can be used to provide a metric of the (focal) distance the viewer is accommodating. The eye position sensor 110 capture rate is sufficient to allow detection of fast eye movements (saccades) angular rate.
May comprise a visible light detector (imager) that image^{s} 3rd an^{d} 4th Purkinje reflections from the eye lens front and back surfaces to sense curvature changes of these surfaces which, when calibrated, are used to provide a metric of the focal distance at which each of the viewer's individual eyes is focused.
Inputs IR light reflections from the eyes
Outputs IR light illumination of the eyes
Eye image

| Specifications | IR light wavelength | 1,500 | nm |
|---|---|---|---|
| | Detector resolution | 100,000 | pixels |
| | Angular rate | <0.2 | degree |
| | Frame update rate | >60 | Hz |
| | Image output interface | MIPI or equivalent interface | |
| | Power interface | 2.5v typical | |
| | Max power consumption | <5 | mW |

1.2 Head Position Sensor 114
Function Sensing (detecting) a viewer's head parameters: position, orientation (pose).
Configuration Comprised of a multiple axis inertial measurement unit (IMU) that uses volumetrically compact micro gyros, accelerometers and geomagnetic sensors preferably integrated within a single IC mounted within the NEAR display system 100 volumetric frame (chassis) 116. The sensing x-axis is aligned with the lateral dimension of the system frame 116, the y-axis is aligned with the optical axis of the system and the z-axis with the vertical axis of the system.
Inputs Viewer's head movements
Outputs Viewer's head orientation relative to the sensor 114 (x,y) frame of reference

| | | | |
|---|---|---|---|
| Specifications | Detection accuracy | <0.5 | degree |
| | Axial rate | <0.5 | degree |
| | Angular rate | <0.5 | degree |
| | Detection updates | >60 | Hz |

1.3 Ambient Scene Sensor 118
Function Sensing (detecting) a viewer's ambient scene.
Configuration At least 1-camera per eye calibrated and aligned with the system optics 106A and 106B.
May be accompanied with an ambient light sensor to detect ambient light intensity.
Inputs Viewer's ambient scene
Outputs Viewer's ambient scene relative to the sensor's 118 (x,y) calibrated frame of reference.
Ambient light intensity

| Specifications | Resolution per camera | >1-4M | pixel |
|---|---|---|---|
| | Frame rate | >60 | Hz |
| | Color | Full color | |
| | FOV | >60 | degrees |

1.4 Optics 106A, 106B
Function Magnifying and relaying a light field generated by the NEAR display system 100 light field modulators 104A, 104B to couple into the HVS 102.
Configuration Binocular optical assembly physically fitting within the envelope of the streamlined envelope of the NEAR Display System's volume and configured to couple the modulated light field from light field modulators 104A, 104B into the HVS 102 with minimal or no discomfort to the viewer at a see-through specification that closely matches the viewer's HVS 102.
Inputs The light field modulated by the light field modulators 104A, 104B and coupled onto the optics input aperture.
Outputs The magnified light field relayed onto an eye-box aligned with the viewer's eyes' optical axis and large enough along (x,y) axes to accommodate the viewer's typical eye movement range of ±4 mm around the optical axis.

| | | |
|---|---|---|
| Specifications | Magnification | >x30 |
| | Monocular FOV | W > 60°, H > 20° |
| | Binocular FOV | W > 75°, H > 20° |
| | Distortion | x (TBR) |
| | Optical aperture | Coupling one or multiple light field |
| | | modulators 104 (e.g., QPIs) |

1.5 Light Field Modulators 104A, 104B
Function Synthesizing the light field based on the digital input coupled into the NEAR Display System 100.
Configuration At least one light field modulator 104A or 104B (e.g., one QPI) per eye calibrated and aligned with the respective NEAR Display System optics 106A, 106B.
Physically the QPIs and their companion chips are fully enclosed within the NEAR Display system envelope.
Inputs Digital data inputs representing the light field to be modulated.
Outputs Light field anglets (directional light bundles) synthesizing the input data in light to the viewer through the NEAR Display system optics 106A, 106B.

| | | |
|---|---|---|
| Specifications | Resolution per | >1M pixel, depending of on the |
| | eye | number of QPIs used. |
| | Frame rate | >60 Hz to include sub-frame rate. |
| | | As required to implement visual |
| | | De-compression. |
| | Color | Full color HD gamut |
| | Optical aperture: | Min. dimension <3.6 mm, mounted |
| | | on the optics edge. |

1.6 Visual Compression Encoder 120
Function Converts the compressed digital light field input into light modulation frame sequences that matches the HVS acuity in foveal and retinal periphery spatial, color and depth resolutions.
Configuration Image (light field) processing software executing on a matched light field processor core 122 having internal processing and memory sufficient to perform the visual compression encoding approximating real-time at least at 60 Hz frame rate.
Physically may be a part of the Light Field Processor (LFP) 122 QPI companion chips fully enclosed within the NEAR Display system envelope.
Inputs Digital data inputs representing a visually compressed light field to be encoded.
Outputs Light field sub-frame modulation sequences representing the visually compressed light field input data compliant with the light field modulators 104A, 104B interface.

| | | |
|---|---|---|
| Specifications | Encoding | Capacity for multiple Light Field Modulators |
| | | (QPIs). |
| | | >1M pixel, |
| | Frame rate | >60 Hz to include sub-frame rate needed to |
| | | implement visual de-compression |
| | Color | Full color HD gamut |

1.7 Gaze/Pose Prediction Function 124
Function Processes the sensed position of the viewer's eyes, output by the eye position sensor 110, as one or more observation vectors through a sequentially updated model of the HVS 102 to predict and estimate (multiple frames) the gaze parameters (direction and depth or pose). The HVS model used may be based on a variance/covariance matrix of the HVS cortical ocular sensory motor signals.
Configuration Gaze/pose predication processing software executes on a matched processor core having internal processing and memory sufficient to perform the prediction model in real-time at least at 60 Hz frame rate.
Physically may be a part of the Light Field Processor (LFP) 122 QPI companion chips fully enclosed within the NEAR Display system envelope, or may be a separate processor, depending on the embodiments of the invention.
Inputs Digital data inputs representing sequential images for the viewer's eyes from eye position sensor 110 and sensed differential orientation of the viewer's head from head position sensor 114.
Outputs Periodic predictions of the viewer's eyes gaze/pose coordinates within the NEAR Display system frame of reference.

| | | |
|---|---|---|
| Specifications | Predication error | <10% |
| | Output rate | >60 Hz |

1.8 Light Field Processor 122
Function Acquisition: Acquires compressed reference holographic elements (or hogels) of the light field segment covering the viewer's gaze zone from the Host Processor 126 using the light field data acquisition protocol then decodes the outer compression layer of the acquired data and reconstructs the full hogel set representing the light field segment covering the viewer's gaze zone. The 1^{st} tier of the Streaming Light Field (SLF) Protocol that identifies the minimal set of light field reference elements (or hogels) based on predicted viewer's eyes pose or the “Gaze Zone”. Periodically generates Gaze Zone acquisition requests to the Host Processor 126 then receives, decompresses, and reconstructs then updates the Gaze Zone light field reference elements (hogels).
Rendering: Converts the decoded and reconstructed light field segment hogels into light field modulation data, performed using received Gaze Zone reference hogels.
Adaptation: Modifying the rendered Gaze Zone light field segment to blend within the ambient scene 108 in brightness, color and depth then incorporates depth cues (effects) based on the input from the ambient scene sensor(s) 118A, 118B and ambient scene objects parameters determined by the Extraction and Mapping function 128.
Configuration The light field processing software executes on a matched processor multi-core having internal processing and memory sufficient to perform the light field segment acquisition, rendering and adaptation in real-time at least at 60 Hz frame rate.
Physically may be a part of the Light Field Processor (LFP) 122 QPI companion chips fully enclosed within the system envelope, or may be a separate processor, depending on the embodiments of the invention.
Inputs Periodic Gaze/Pose predictions from Gaze/Pose Prediction function 124.
Viewer's sensed current eyes and head positions from sensors 110, 114.
Sensed current ambient scene 108 from sensors 118A, 118B.
Gaze Zone reference hogels from Host Processor 126.
Parameters of Ambient Scene objects in Gaze Zone from Extraction and Mapping function 128.
Outputs Frame rate light field data to the Visual Compression Encoder 120.
Gaze Zone reference hogels updates request to Host Processor 126.
Frame rate updates of displayed light field objects within Gaze Zone to the Extraction and Mapping function 128.

| | | |
|---|---|---|
| Specifications | Processing frame rate | >60 Hz |
| | Output frame rate | >60 Hz |
| | Latency | <10% Frame Period |

1.9 Extraction & Mapping function 128
Function Performs the extraction and mapping of objects in the ambient scene 108 by analyzing the output images of the ambient scene sensors 118A, 118B (e.g., cameras) in conjunction with the viewer's detected and predicted eye and head parameters including focus depth. The extraction and mapping of objects in the ambient scene 108 is performed through extraction of the parameters of newly added objects in the viewer's Gaze Zone, adding these new objects to the existing map then sequentially updating the parameters of objects previously mapped each time any of these objects reappear in the viewer's Gaze Zone.
The Extraction and Mapping Function 128 may continuously propagate and predict the parameters (position and orientation) of moving ambient scene objects relative to the viewer's Gaze Zone within the NEAR Display System frame of reference.
The Extraction and Mapping Function 128 may track and maintain the position of virtual objects, including system prompting and control icons, within the NEAR Display System frame of reference (NEAR Display System may have the ability to place these icons within the viewer's 360° surroundings).
Configuration The Extraction and Mapping software may run on a dedicated processor core having internal processing and memory sufficient to perform the ambient scene and virtual objects parameters extraction and mapping in real-time at least at 60 Hz frame rate. The processor core may be configured as a dedicated core integrated within the Light Field Processor (LFP) 122 QPI companion chip fully enclosed within the system envelope, or may be a separate processor, depending on the embodiments of the invention.
Inputs Periodic Gaze/Pose predictions from Gaze/Prediction function 124.
Viewer's sensed current eyes and head positions from sensors 110, 114.
Sensed current Gaze Zone ambient scene 108 from sensors 118A, 118B.
Outputs Frame rate updates of Gaze Zone objects parameters.

| | | |
|---|---|---|
| Specifications | Processing frame rate | >60 Hz |
| | Output frame rate | >60 Hz |
| | Latency | <10% Frame Period |

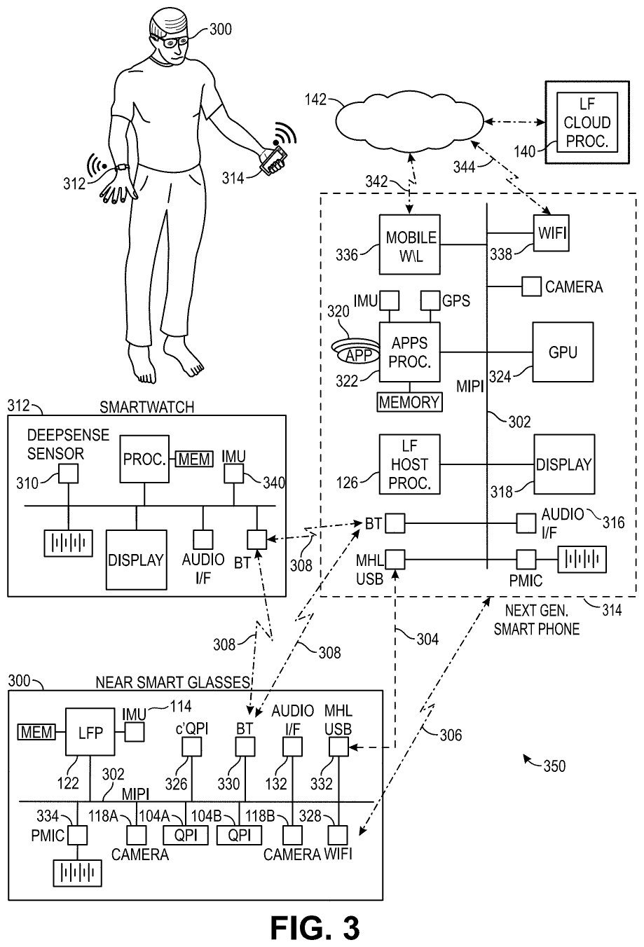

1.10 Connectivity Function 130
Function With reference to FIG. 3, connects the NEAR Display System 300 backplane interface bus (MIPI) 302 to the human interface sensors set (including, for example, head position sensor 114, eye position sensor 110, and touch sensor(s) 134A, 134B) audio interface(s) 132A, 132B and the Host Processor 126. The Connectivity Function 130 uses electrical, optical and wireless interfaces to achieve the desired set of interfaces. The Connectivity Function 130 interfaces electrically to System backplane interface bus using the Mobile Industry Processor Interface (MIPI) 302 and, in the wired interface mode, to the Host Processor 126 using Mobile High-speed Link (MHL) interface 304 for data and Auxiliary Power. The Connectivity Function 130 may interface wirelessly using Wi-Fi 306 to the Host Processor 126 and using Bluetooth 308 to a Gesture sensor 136. The Connectivity Function 130 also interfaces electrically, via the System backplane interface bus MIPI 302, to the Light Field Processor (LFP) 122, the Audio Interface 132, the Touch Sensor 134 and the Power Management Functions 138.
Configuration The Control Processing software of the Connectivity Function 130 executes on a matched processor core having internal processing and memory sufficient to perform the system interface function in real-time at least at 60 Hz frame rate.
Physically, the Control Processing of the Connectivity Function 130 may be integrated as a dedicated core within the Light Field Processor (LFP) 122 companion chip supported by dedicated chips for Wi-Fi, Bluetooth and MHL interface chips, all fully enclosed within the NEAR Display system enclosure envelope. Alternately, the Control Processing of the Connectivity Function 130 may be supported by a separate off-the-shelf small footprint Connectivity Control Processor supported by dedicated chips for Wi-Fi, Bluetooth and MHL interface chips.
Inputs Gaze Zone reference hogels updates request from the Light Field Processor 122
Gaze Zone reference hogels updates from the Host Processor 126
Gesture sensor 136 data via Bluetooth wireless link protocol 308
Touch sensor 134 data
Audio Interface 132 data (possibly be connected wirelessly)
Auxiliary power interface through either a dedicated interface or through MHL 304
Outputs Gaze Zone reference hogels updates request to the Host Processor 126
Gaze Zone reference hogels updates to the Light Field Processor 122
Gesture sensor 136 data to the Light Field Processor 122
Touch sensor 134 data to the Light Field Processor 122
Interface data to the Light Field Processor 122
Auxiliary power to Power Management Function 138

| | | |
|---|---|---|
| Specifications | Wi-Fi wireless Interface data rate | >50Mbps |
| | Bluetooth wireless Interface data rate | >10Mbps |
| | MHL wired interface data rate | >1.5Gbps |
| | Interface | MIPI full interface |

1.11 Gesture Sensor 136
Function Detects the viewer's hand gestures including hand rest and fingers movements as well as the viewer's hand position within the system frame of reference. The detected hand and fingers gesture movements are detected (or identified) and cataloged then encoded into gesture commands data output. The viewer's hand position within the system frame of reference may be transformed onto the light field frame of reference in order to correlate viewer's gesture to the light field (real plus augmented).
Configuration With reference to FIG. 3, a dense ultrasound micro-scale transducer array sensor (herein referred to as DeepSense) 310 is preferably integrated within a hand-wearable device 312 (e.g., a smart watch) which includes a wireless (Bluetooth) interface 308 to smart glasses 300.
The DeepSense software may execute on a matched processor core physically integrated in the Light Field Processor (LFP) 122.
Inputs Viewer's hand and fingers gestures interactions with the light field (real plus augmented).
Outputs Viewer's hand coordinates data within the system frame of reference.
Viewer's fingers and hand gestures data.

| | | |
|---|---|---|
| Specifications | Gesture detection accuracy | >99% |
| | Update rate | >60 Hz |
| | Latency | <10 ms |

1.12 Touch Sensor 134A, 134B
Function Detects the viewer's hand touches on a dedicated touch pad positioned on the
NEAR Display System outer surface to communicate certain viewer's commands.
Configuration Touch sensor pads preferably integrated into the outer surface of the NEAR display system glasses arms.
The Touch Control software may execute on a matched processor core that is physically a part of the Light Field Processor (LFP) 122.
Inputs Viewer's hand touch commands.
Outputs Viewer's hand touch data to the LFP 122.

| | | |
|---|---|---|
| Specifications | Touch detection accuracy | >99.9% |
| | Update rate | >60 Hz |
| | Latency | <10 ms (TBR) |

1.13 Audio Interface 132
Function Detects the viewer's voice commands and audio output.
Generates audio outputs to the viewer.
Voice encoding/decoding (Vocoder) and voice recognition.
Configuration The Audio Interface 132 speaker and microphone are integrated within the NEAR Display System 300 chassis physical envelope. The audio speaker may be designed as a bond conduction-type speaker integrated within the interior of the NEAR Display System glasses arm close to the viewer's ears.
The Audio Interface software can execute either on a dedicated chip or on a matched processor core within the Light Field Processor (LFP) 122.
The entire Audio Interface Function 316 of the NEAR Display System can be integrated within the Host Platform 314 (e.g., the smartphone) with its input and output, leveraging the audio interface capabilities of the Host Platform 314.
Inputs Viewer's voice commands and audio input.
Outputs Audio output to the viewer's ears.

| | | |
|---|---|---|
| Specifications | Voice commands | >99.9% |
| | detection accuracy | |
| | Voice recognition | Speaker independent |
| | Vocoder rate | 8 Kbps |
| | | (wireless mobile protocol compatible) |

1.14 Power Management 138
Function Manages system power and allocate power to active system functions.
Converts DC power source voltage to required operating voltage levels.
Selects the system power source, battery versus auxiliary power, in wired mode.
Manages batteries charging in wired mode.
Controls system “Sleep Mode” and related minimal power supply to critical system functions.
Configuration The Power Management Function 138 may run on a dedicated chip (Power Management IC, PMIC) integrated within the NEAR display system envelope or could instead be run on a QPI power management companion chip since the latter is responsible for generating and supplying all of the system voltage levels.
In either case, the Power Management microcode or firmware executes on a dedicated state machine within the PMIC or QPI power management companion chip designed to perform such function.
Inputs Power from the battery or auxiliary power source.
Power allocation requests from all functions.
Outputs Required voltage levels to all chips of NEAR Display System 100, 200, 300.
Battery charge commands.
Power management commands to all functions.
Specifications Power Management Efficiency >95%

1.15 Host Processor 126
Function Performs the 2nd tier of the Streaming Light Field (SLF) Protocol; specifically, receiving and responding to the Gaze Zone acquisition requests from the LFP 122. Identifies light field reference elements (or hogels) of the “Extended Gaze Zone” based viewer's gaze updates provided by the LFP 122.
Acquires and stores the light field reference elements (or hogels) of the “Extended Gaze Zone” from the Cloud Processor 140.
Relays Gaze Zone light field reference elements to the LFP 122 via the Connectivity Function 130 wireless or wired interface.
Relays the audio voice command and audio from/to viewer when the NEAR Audio Interface Function 132 is integrated within the Host Platform (the smartphone) 314.
Relays the Host Platform 314 operating system screen 308 output to the NEAR Display System when NEAR Display System is supporting the Host Platform display function.
Relays the output local screens and Streaming Light Field (SLF) commands generated by Application software (Apps) 320 running on Host Platform Application Processor 322 to NEAR Display System.
Relays NEAR display In-App and In-Use invocations to the Cloud Processor 140.
Configuration The Host Processor 126 may be integrated within the Host Platform enclosure.
The Host Processor software executes either on a dedicated chip or on processor core that may physically be a part of the Host Platform 314 computing environment.
The Host Processor 126 fulfills a function similar to the Graphic Processor Unit (GPU) of current mobile (2D) displays. The Host Processor may absorb the GPU function. Alternatively, the Host Platform 314 may have its own GPU 324 to fulfill this function.
Inputs Gaze Zone acquisition requests from the LFP 122 via Connectivity Function 130. Extended Gaze Zone light field reference elements from the Cloud Processor 140.
Local screens and SLF commands generated by Apps.
Outputs Gaze Zone light field reference elements to NEAR Display System LFP 122.
Audio voice commands to NEAR Display System.

| | | |
|---|---|---|
| Specifications | Processing frame rate | >60 Hz |
| | Output frame rate | >60 Hz |
| | Latency | <10% Frame Period |

1.16 Cloud Processor 140
Function Performs the third tier of the Streaming Light Field (SLF) Protocol; specifically, receiving and responding to the Extended Gaze Zone acquisition requests from the LFP 122.
Performs the tallying of users In-App and In-Use invocations of the NEAR Display System and processes web-based charges.
Acquires and stores the light field input and performs Light Field Server Function.
Logs NEAR display users' In-App and In-Use invocations.
Configuration The Cloud Processor would be integrated within a Cloud Server.
The Cloud Processor software executes on a dedicated cloud computing server.
Inputs Extended Gaze Zone acquisition requests from the Host Processor 126 via cloud 142.
NEAR display users' In-App and In-Use invocations action.
Outputs Extended Gaze Zone light field reference elements to the Host Processor 126.
NEAR display users' In-App and In-Use web-based charges action.

| | | |
|---|---|---|
| Specifications | Processing frame rate | >60 Hz |
| | Output frame rate | >60 Hz |
| | Latency | <10% Frame Period |

### 2. NEAR Display System Modes of Interaction

NEAR Display System Modes of Interaction are integrated within multiple functions that together enable the following modes for the viewer's interaction with the system:

### Voice Command (VC):

Implemented through the Audio Interface function 132 and includes the capabilities to select and activate one of multiple user configured or system operational commands. The NEAR display system may also include the capability for joint multi-modal commands that include, for example, voice command (VC) of objects or icons selected visually, by gesture or through touch.

### Gesture Interaction (GI):

Implemented through the Gesture Interface function 136 and includes capabilities to fully interact with the displayed (modulated) light field content. GI of the NEAR display system may include localization of the viewer's hand within the display volume and decoding of the viewer's hand rest and fingers configuration. With all possible combination of the viewer's hand rest and fingers configurations, it is possible for the NEAR display system viewer to issue or express a rich set of commands ranging from a simple “point or select” commands to a complex syntax commands such as, for example, GI commands to expand, retract, pull to front or push to back of view contents, (x,y,z) roll and scroll. GI may offer the NEAR display system viewer the richest way for the viewer to interact with the displayed content. It may also create (user selected) multi-modal commands by combining the GI commands with other modes of interaction as, for example, when the viewer selects an object or an icon to use by GI action and then uses a VC to activate or open it.

### Visual Select (VS):

Implemented through the eye position sensor 110 function and includes the capability to select either virtual or real objects within the viewer's field of view (FOV) when the viewer is focused on such objects of interest. This is made possible using the gaze direction and inter pupillary distance (IPD) detected by the eye position function in combination with the Extraction & Mapping function 128 to localize objects, either real or virtual, within the viewer FOV. Further actions on Visually Selected (VS) objects can be added using VC or GI commands.

### Touch Command (TC):

Use of the touch sensor(s) 134A, 134B enables the NEAR display system viewer to issue a specific set of commands by touching, dragging or tapping on either one of the two touch pads configured on the outer surface of the NEAR display system glasses arms. TC can be used alone or in conjunction with VC, GI or VS to expand the command set of the viewer's interaction. TC can also be used to confirm or assert commands issued by the viewer using other interaction modes.

### Augmented Cross Modal (ACM) Perception:

The NEAR display system also incorporates “Cross Modal Perception” design provisions in presenting correlated visual and sound prompts that augment the viewer's reality in both modal perceptional aspects. In that regard, the NEAR display system may include an ambient sound sensor (not depicted in FIG. 1) which output may be correlated with the visual ambient scene sensor(s) 118A, 118B and the results of which are incorporated in visual (and possibly audio) augmentation to the viewers' physical reality that corresponds with the viewer's cross modal perception. Examples may include alarming sounds from the ambient surroundings of the viewer detected by the NEAR display system being accompanied with a visual alert icon that visually augments the viewer's reality to engage a viewer's cross modal perception of the alarm. Another example may be to associate each class of visual alert icon with a unique sound that engages the viewer's cross modal perception of the icon's occurrence.

### 3. Wearable Display System Operational Modes

### NEAR Display System Augmented Reality (AR) Modes

The NEAR display system may be configured to operate in either a first Stereo Vision mode or second Light Field mode. In the Stereo Vision mode, the system optics 106A, 106B and light modulation function operate at a single depth (similar to MS-Hololens) with objects” depth being adjusted (or modulated) using the binocular disparity and other depth cues. In this first mode of operation, the displayed object depth is set forth by the NEAR display system for the viewer to focus on. In the second Light Field mode, the NEAR display system modulates multiple views, allowing the viewer to selectively focus on objects of interest. In this second mode of operation, objects displayed in the light field are viewer focusable.

The addition of the Light Field mode requires adaptation of the light modulator(s) 104A, 104B (QPI) micro optics and the addition of the light field related processing including light field compression and streaming light field (SLF) protocol. The processing capabilities needed to incorporate the Light Field Mode into the NEAR display system are added at a remote Host Processor emulator and are connected either by wire or wirelessly to the rest of the system. In other versions, the processing capabilities needed to incorporate the Light Field Mode, or at least a meaningful subset if it, are implemented within the system envelope using multiple QPI chips or a single LFP chip.

### Virtual Reality (VR) Mode

Variants of the NEAR display system may include a mode that allows the system to operate as a Virtual Reality (VR) display. This mode may be implemented by the addition of a variable dimming or variable translucence optical layer that at least partially covers the system optical aperture (glasses lens) 106A, 106B. For viewer safety considerations, this added mode may be viewer-commanded and only enabled by the system when the viewer is not mobile. It is possible to process the output of the Inertial Measurement Unit (IMU) sensor 114 included to sense the viewer's head position to infer (or detect) the mobility mode of the viewer. The addition of the dimming optical layer may involve modification of the NEAR display system optical lenses and the addition of software and hardware.

### Sunlight Viewable (SV) Mode

The dimming function made possible by the addition of the dimming optical layer may also be viewer commanded in the mobile operational modes at lower dimming levels in order to increase the system contrast. This is in particular a useful mode in high ambient light brightness, for example outdoor sunlight. The level of ambient light brightness may be detected by the NEAR display system Ambient Scene Sensor(s) 118A, 118B and allow appropriate low dimming levels (proportional with the detected ambient light brightness) that do not hamper the viewer's mobility and safety and be enabled to enhance the system contrast. The Sunlight Viewable (SV) mode may be set to be invoked automatically depending on detected ambient light brightness with parameters preset by the viewer within the system operational safety levels.

A coarsely pixelated version of the dimming layer added to enable the modal features described above may be provided to enable the display of opaque objects in the NEAR display system AR mode of operation.

### 4. Wearable Display System Design Objectives & Strategy

A NEAR display system aspect is to enhance the visual mobile experience to enable growth in the mobile digital media market. In general, AR/VR wearable displays have been projected by market analysts as the technology most likely to succeed in achieving that objective—coined by market analysts as “the Next Big Thing”. However, ongoing technology and product development trends are mostly focused on niche markets primarily because these trends lack what it takes to effectively address the mobile market; namely, not achieving the most important mobility criteria of being small and light weight mobile devices that can be used for extended or even a reasonable period of time. The NEAR display system, according to embodiments of the invention, enables a mobile display system that appeals to the masses of mobile users in being a streamline, small and light weight and can be used for an extended period of time while exceeding the display performance and capabilities of current mobile displays such as LCD and OLED.

The NEAR display system described herein achieves both of its product and market objectives by first being a part of the existing mobile ecosystem then evolving to ultimately become the main driver in defining the visual mobile experience of the next generation mobile. This strategy is enabling in multiple ways and, by being a complement to mobile devices, the NEAR display system complexity burden, needed as explained earlier to enable a visual mobile experience that transcends that offered by current mobile displays, is partially alleviated as the NEAR display system off loads some of that complexity to the mobile device in order to make it possible to achieve the target small size, light weight and extended use targets.

This strategy enables high mobile market penetration for the NEAR display system provided that its design achieves the streamline, small volume, light weight and extended use targets needed for mass mobile user adoption. This goal is achieved by multiple design features of the NEAR display system, including:
1. The light field modulator(s) QPI being volumetrically and power efficient enables the NEAR light field modulation and optics functions to also become equally efficient in these rather important design aspects.
2. The QPI optical aperture being matched to the human visual system (HVS) allows the QPI to also match the light it modulates to the HVS, which results in additional reduction in processing complexity and related power consumption.
3. The NEAR display system Eye and Head Position Sensing combined with the Gaze/Pose Prediction functions leverages the HVS capabilities to localize, map and track objects in the light field instead of adding machine vision type capabilities that adds complexity and bulkiness, thus allowing the NEAR display system to achieve even further reduction in processing complexity and related power consumption.
4. The NEAR display system Visual Compression Encoding function 120 leverages the HVS built-in decompression capabilities to reduce the light field decompression processing and interface bandwidth to the QPI, thus allowing the NEAR display system to achieve even further reduction in processing complexity and related power consumption.
5. The NEAR display system light field acquisition (part of the Light Field Processing function) combined with the Gaze/Pose Prediction function enables the NEAR display system to acquire a high level of detail only for the part of the light field that the viewer is focused on or interacting with. Again this allows the NEAR display system to achieve even further reduction in processing complexity and related power consumption.
6. The multi-tier Streaming Light Field (SLF) protocol implemented as part of the NEAR display system three tiers distributed computing capacity comprising the NEAR display system LFP 122, Host and the Cloud Processors 126 and 140, respectively, allows light field bandwidth to be managed progressively across the three processing layers prompted by the viewer's gaze and interaction information. This way, larger portions of the light field data sets are handled by Cloud processing while lesser bandwidth of the extended gaze zone is handled by Host processing and the smallest possible gaze zone data set is handled by the LFP within the NEAR Display System physical wearable envelope. This multi-tier approach of the NEAR display system solves the problems caused by the overly large light field data size that make it nearly impossible for competing solutions to handle.

The NEAR display system addresses the cost barrier to market entry by adopting a software-like sales model. This strategy is made possible by the fact that through its multi-tier SLF protocol, the NEAR display system has a direct internet connection via its associated Cloud Processor (Server) that is designed to tally the per user In-App and In-Use invocations and activate related web-based charges collection. With this strategy, the initial upfront charges to the mobile user can be minimized in favor of collecting recurring In-App and In-Use charges, or even advertisement charges, in particular for high spec visual features such as light field content distribution and display, for example. Part of this strategy, permits working with mobile content developers to promote the high spec features offered by the NEAR display system in order to proliferate mobile apps that use the NEAR display system high spec features.

In summary, the NEAR display system strategy to achieve the objective of being the next mainstream mobile display is to first complement (or attach to) current mobile devices in order to gain market penetration through multibillion units of deployed market base and also to off load to the mobile device some of the complexity burden to make the NEAR display system achieve the small size, light weight and extended use targets sought after to achieve mass adoption by mobile users. The latter objective is also achieved by leveraging the HVS capabilities to the fullest extent possible and making full use of the advantages offered by the QPI. Complementing these product and market access strategies is a software-like selling strategy that is designed to reduce the cost barrier to market entry and to make possible a recurring and high margin revenue from the deployed NEAR display system units.

### 5. NEAR Display Hardware/Software Architecture

With reference to FIG. 3, the NEAR Display System operates as a part of a three nodes Personal Area Network (PAN) 350, consisting of the NEAR Display System 300, the smartphone 314 (or other smart mobile device) and the smartwatch 312, connected to the Cloud Processor 140 via Mobile Wide Area Network (MWAN) and/or Wireless Local Area Network (WLAN) wireless connectivity links 342 and 344 respectively. Each of the three nodes of the NEAR-PAN 350 achieves a unique role with the combined objective to provide the mobile users with the mobile services they are accustomed to within a vastly enhanced mobile visual experience that extends from stereo vision to AR or VR. In the NEAR-PAN 350, the NEAR Display System 300 primary role is the visual interface with the mobile user while the primary role of the smart watch 312 is the gesture interface with the mobile user and the primary role of the smartphone 314 is the interface with the Cloud Processor 140 via its MWAN and WLAN interface capabilities. The three nodes of the NEAR-PAN working together make it possible to realize the enhanced visual experience while achieving the wearability objectives and without reducing the user mobility (the term “mobility” is meant to express maximum accessibility to information at minimum impact to the user's freedom to move). Offloading the Cloud interface to the smartphone and the gesture interface to the smartwatch make it possible to realize high mobility while achieving small size and light weight plus extended use period that make the NEAR Display appeal to the masses of mobile users. Further contributing to the realization of these objectives is the offloading of the light field (LF) processing in part to smartphone via the NEAR-PAN then leveraging smartphone wireless connectivity to offload more of the light field (LF) processing to the Cloud processor. With this architecture, the three nodes of NEAR-PAN are directly contributing together in making the transition to the next generation mobile visual experience with each of the three nodes contributing its unique capabilities and together contributing to making wearability and mobility possible.

FIG. 3 shows exemplar distributed computing hardware and software architecture (environment) realized by the three nodes 300, 312, 314 of the NEAR-PAN 350. At center stage of the NEAR-PAN architecture is the NEAR Display System node 300 that enables the next generation mobile visual experience. Besides the light field modulator (QPI) chipset; namely, the QPI light modulator chip and its companion power supply (c′QPI) chip 326 and interface (cQPI) chip (not shown), the NEAR Display System node 300 is integrated using off-the-shelf chips and components currently being used in existing mobile devices, like the smartphone and smartwatch. Complementing the QPI chipset is the LFP chip 122 which hosts the software that executes the majority of the NEAR Display System functions described earlier.

As shown in FIG. 3, with QPI onboard visual processing capabilities, it becomes possible to integrate the majority of the remaining processing functions of the NEAR Display System on the LFP chip 122 which may be implemented in deep nano-scale CMOS technology using multi-core parallel matched instruction set processing (MISP) architecture to realize minimal size and power consumption while providing all of the processing capabilities needed to realize the NEAR Display System functions described earlier. The remaining components of the NEAR Display System may be off-the-shelf mobile components originally designed for the smartphone, including, for example, the wireless connectivity chips for Wi-Fi 328 and BT 330, the IMU chip 114, the wired connectivity MHL/USB chip 332 and the Power Management Integrated Circuit (PMIC) chip 334. In order to make that possible, the NEAR Display System may use the same MIPI backplane interface bus 302 currently used in most smartphone devices. In effect with this architecture, the NEAR Display System is remotely (wired or wireless) extending the smartphone MIPI interface bus thus allowing the NEAR Display System's LFP 122 to interface seamlessly with the smartphone computing resources in particular the Mobile Applications Processor (MAP) 322 and the Cloud interface wireless chips (MWAN 336 and WLAN 338). As mentioned earlier, the functions of PMIC 334 for the NEAR Display System is integrated into the QPI power management chip companion (c′ QPI) 326 to make it the primary power management chip for the NEAR Display System. With this architecture, it becomes possible to meet the small size volumetric, light weight and low power constraints of the NEAR Display System to achieve its wearability objectives.

The architecture of the NEAR-PAN smartwatch node 312 is largely the same as current smartwatch with the exception of replacing the biometric sensor with, for instance, the Ostendo DeepSense gesture sensor 310 as is disclosed in U.S. patent application Ser. No. 15/338,189, the entirety of which is incorporated herein by reference. The DeepSense device enables detection of an expanded set of human hand, wrist and finger gestures while expanding the set of detectable biometric parameters. The viewer's hand position is detected by an IMU chip 340 integrated within the smartwatch and its output together with the DeepSense device output is relayed to the NEAR Display System via the Bluetooth (BT) wireless interface 308 which is also already a part of the current smartwatch. In effect, the NEAR-PAN smartwatch 312 interfaces with the NEAR Display System 300 via a BT wireless link to support of the viewer's gesture interaction with the displayed contents while intermittently interfacing with the smartphone 314 as is typical in current smartwatch devices. In the NEAR-PAN architecture, therefore, the smartwatch functional purpose is elevated from just being a wireless remote control interface for the smartphone to becoming an integral part of the next generation mobile communication environment, providing the equivalent function to the NEAR Display System operation as the touch screen does for current mobile displays. It is expected that such an elevated and expanded role of the smartwatch will ultimately make it a more viable mobile device with the expectation of much higher market penetration than it is currently able to achieve in the mobile market. It's worth mentioning that besides its expansive gesture repertoire, the passive nature of the DeepSense device makes it resilient to interference, involves limited interface bandwidth and has minimal power and volumetric impact on the NEAR Display system, thereby meeting the volumetric, weight and power design constraints of the NEAR Display system wearability objectives.

The architecture of the NEAR-PAN smartphone node 314 is largely the same as current smartphone with the exception of adding (or replacing altogether) the Graphic Processing Unit (GPU) with a LF Host Processor 126 which is designed to remotely reciprocate primarily with and support the NEAR Display System LFP 122 connectivity to the LF Cloud Processor 140 via the smartphone MWAN 342 and WLAN 344 connectivity. Within the context of the smartphone operation, the LF Host Processor 126 supports the same type of function with the substantially the same type of Application Programming Interface (API) as the current GPU supports the existing display of the smartphone. In that context, the next generation of smartphone Apps 320 compatible with either stereo vision or LF display modes execute on the smartphone Mobile Application Processor (MAP) 322 as existing Apps currently operate except that the MAP 0/S has the ability to control the routing setup of the display data received through the smartphone MWAN and WLAN connectivity to either one of the display ports DSI-1 or DSI-2 of the smartphone backplane MIPI bus to support the display of the received visual data using either the smartphone built-in display screen 318 via its existing GPU 324 or using the NEAR Display System via the LFP 122, respectively. With this approach, next generation mobile Apps compatible with either stereo vision or LF display modes are able to operate under the current smartphone 0/S since the capability of supporting two display ports is already built-in such operating system environments. Another advantage of the NEAR-PAN approach is that it offloads all of the mobile Apps processing to the smartphone MAP 322 thus making it possible to realize the small, light weight and extended use targets that make the NEAR Display System appeal to the masses of mobile users. Yet another advantage of the NEAR-PAN approach is that it substantially maintains and supports the existing mobile Apps 0/S environment, thus reducing the Apps developer effort and focusing on supporting the API of the LF Host Processor 126. This approach is compatible with the most recent trend in the next generation of smartphones that already recognizes the need to expand the functional capabilities of current GPUs to support AR/VR displays.

FIG. 3 shows the connectivity between the three nodes 300, 312, 314 of the NEAR-PAN 350 which includes:
1. Full connectivity between the three nodes using BT wireless links 308 primarily for exchange of control and sensor data;
2. Wi-Fi connectivity 306 between the NEAR Display System 300 and the smartphone to support the routing of wideband display data received via the smartphone MWAN and WLAN links 342, 344 and routed through the LF Host Processor 126; and,
3. Wired MHL/USB connectivity 304 between the NEAR Display System and the smartphone to support power charging as well as wired mode routing of wideband display data received via the smartphone MWAN and WLAN links and routed through the LF Host Processor 126.

Although with this NEAR-PAN nodes connectivity the routing of wideband display data received via the smartphone to the NEAR Display System is possible using either wireless or wired connectivity, wireless connectivity is envisioned to be the primary and preferred connectivity mode with the wired connectivity mode being used primarily when the NEAR Display System batteries need to be recharged. The NEAR-PAN 350 operates as a closed personal network with the established connectivity between the three nodes being dedicated BT 308 and Wi-Fi 306 channels. With this approach, both the BT and Wi-Fi protocols are truncated to eliminate the protocol overhead associated with ad hoc connectivity modes and in this configuration, both the NEAR Display System and smartwatch recognize pairing requests only from their associated NEAR-PAN smartphone node, thus making their link bandwidth available for the exchange of NEAR-PAN control and visual data rather than being wasted on supporting contention protocol overhead.

The Wi-Fi connectivity of the NEAR-PAN smartphone node may have to occasionally support two Wi-Fi links 306, 344 simultaneously, one (306) to connect the NEAR Display System to the smartphone and another (344) to connect the NEAR-PAN to the internet via the smartphone WLAN link when the smartphone MWAN link is not accessible or does not have a suitable link quality. In order to support such an operational condition of the NEAR-PAN, the next generation smartphone may include connectivity that is designed to support NEAR-PAN operation, especially in the LF mode of operation, to include two Wi-Fi chips 338 with one being dedicated for supporting the connectivity between the NEAR Display System 300 and the smartphone 314. Certain stereo vision sub-modes may be supported by the BT link 308 between the NEAR Display System and smartphone, especially given the recent trend of increased bandwidth BT becoming available.

The NEAR-PAN connectivity is also configurable to allow pairing with other displays within the NEAR-PAN coverage area such as, for example, the automotive head-up display (HUD) through the automobile info-tainment system, desktop, laptop, tablet or home entertainment displays. This multi-display pairing (or networking) capability will ultimately evolve to make the NEAR-PAN able to integrate the light field from the multiple displays for offering unprecedented light field viewing experiences. NEAR-PAN interconnectivity with other viewers' NEAR-PAN will also include a capability that will enable interactive viewing in support of games and mobile sharing.

The distributed computing environment of the NEAR-PAN 350 supplemented by Cloud processing of its associated LF Cloud Processor 140 spreads the large computing load of the next generation mobile LF Display systems across multiple computing nodes thus making it possible to realize the size, power and extended use targets of the NEAR Display System. The primary functional allocations of the NEAR display system hardware and software are highlighted in FIG. 3 and summarized below:

### NEAR Display System Hardware & Software

NEAR Display—1. Multiple (QPI+c'QPI) chipsets 104, 326 to modulate light field
2. Light Field Processor (LFP) 122 to perform multiple functions:
   a. LF Acquisition, Rendering & Adaptation
   b. Gaze/Pose Prediction
   c. Extraction & Mapping
   d. Streaming LF Protocol (Tier-1)
smartphone—3. LF Host Processor 126:
   a. Controls interface with Apps running on App Processor in mobile
   b. LF data interface from mobile to NEAR display system
   c. Streaming LF Protocol (Tier-2)
smart watch—4. DeepSense 310:
   a. Detects the viewer's hand rest and finger gestures
   b. Detects the viewer's hand position
Cloud Server—5. LF Cloud Processor 140 software
   a. LF point of service (Head-end) for compression & interactive LF service
   b. Streaming LF Protocol (Tier-3)
   c. In-App and In-Use tallying & charge processing

### 6. NEAR Display System Designs

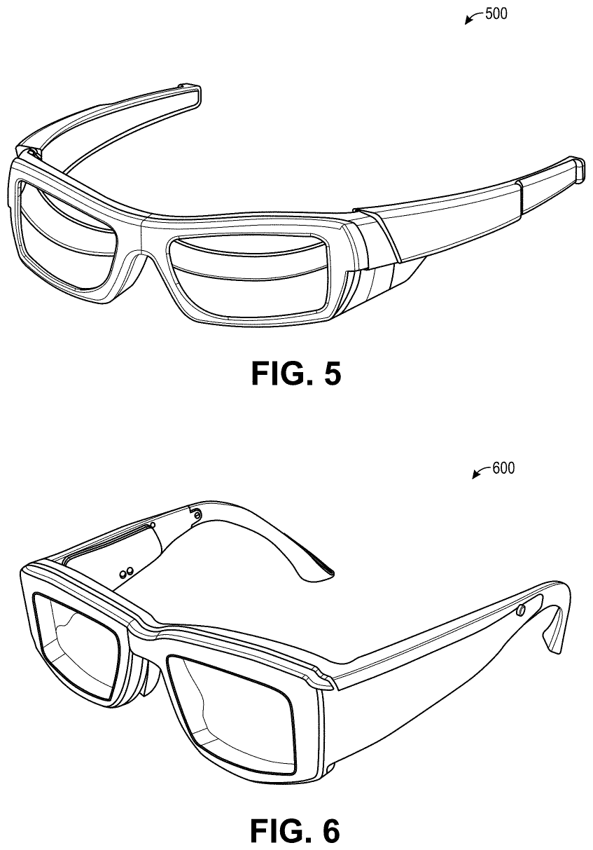

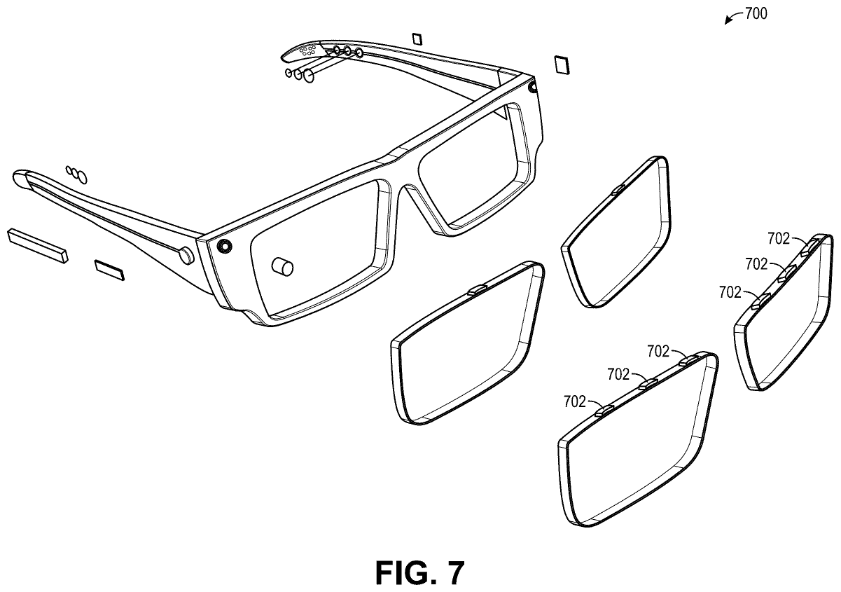

The NEAR Display System design has been validated in a series of product generations having progressively increased functional capabilities. The product generations are designated OST-1 1000 (FIG. 10), OST-2 500 (FIG. 5), OST-3 600 (FIG. 6) and OST-4 700 (FIG. 7). OST-1, OST-2 and OST-3 use variants of relay and magnification optics designs with the QPI optically coupled directly onto the NEAR display system optics either at the temple side of the NEAR display system glasses lens edge in the case of OST-1 and OST-2 and at the top side of the NEAR display system glasses lens edge in the case of OST-3 and OST-4. In addition, OST-3 and OST-4 designs allows the coupling of up to three QPIs per eye to progressively increase the NEAR Display System Field of View (FOV), viewing eye-box size and total per eye display resolution. OST-1 and OST-2 optics design make use of separate relay and magnification reflectors, while OST-3 and OST-4 make use of a combined relay and magnification optics. OST-3 and OST-4 designs make use of waveguide optics including free-form refractive optical (FFO) and detractive waveguide optics (WGO) implemented using either surface relief or volume relief WGO imprint design methods. The combined series of NEAR Display System OST designs progressively achieve increasing FOV with angular diagonal extending from 40° to 150°. The eye position sensors and the ambient scene sensors are seamlessly integrated within the OST-3 and OST-4 optics (glasses lens) design in order to achieve the highest volumetric efficiency.

When using a single QPI per eye, any of the NEAR Display Systems achieves either n-HD (360×640) or HD (720×1280) resolution per eye. When using two QPIs per eye, either NEAR Display System OST-3 or OST-4 designs achieve up to 2 M pixel per eye. When three QPIs are used per eye in either NEAR Display System OST-3 or OST-4 NEAR Display System designs achieve up to 3 M pixels per eye. A design configuration 700 of NEAR Display System OST-4, illustrated in FIG. 7, includes multiple QPIs 702 optically coupled directly onto the NEAR display system optics at the top and bottom sides of the NEAR display system glasses. With this QPI-coupling configuration, the NEAR Display System OST-4 achieves up to 6 M pixels per eye of resolution with a vertical FOV extending up to 40°. It should be noted that the design methods of direct optical coupling of a multiplicity of QPI onto the NEAR display system relay and magnification optics (glasses lens) edges, unlike prior art methods in which the image is coupled onto the system optical aperture surface, has the advantage of not obstructing NEAR Display System see-through optical aperture and thus provides high see-through optical aperture efficiency. In addition, the design methods of direct optical coupling of a multiplicity of QPIs onto the NEAR display system relay and magnification optics (glasses lens) edges allows the design to be tailored to the market design requirements, in terms of the pixel resolution per eye and the size of the FOV, from low to high end products while more importantly still providing high see-through optical aperture efficiency across an extended range of product offerings.

It should also be noted that the NEAR Display System design criteria of matching the HVS 102, combined with the design methods of direct optical coupling of a multiplicity of QPI onto the NEAR display system relay and magnification optics (glasses lens) edges to achieve high pixel resonation and wide FOV enable the NEAR Display System to be designed to achieve substantially higher effective pixel resolution within the fovea region compared to the peripheral region of the viewer's eyes retinas while still able to meet the volumetric, weight and power constraints paramount for achieving wearability.

Depending on the number of QPIs used in the NEAR Display system, designs are able to run in either a stereo vision mode (Single depth optics (1-views per eye)) or light field mode (Viewer focusable depth light field optics (>8-views per eye)) with the former being integrated and demonstrated and made available as a product first simply because it is less complex than the light field mode. Also the capabilities of the NEAR display system early generation LF Host Processor 126 could be first implemented on a remotely packaged hardware interfacing with the NEAR Display prototype either connected by wire or wirelessly until the Form, Fit and Function (F³) versions of the LF host processor integrated within the envelope of smartphones 314 becomes available.

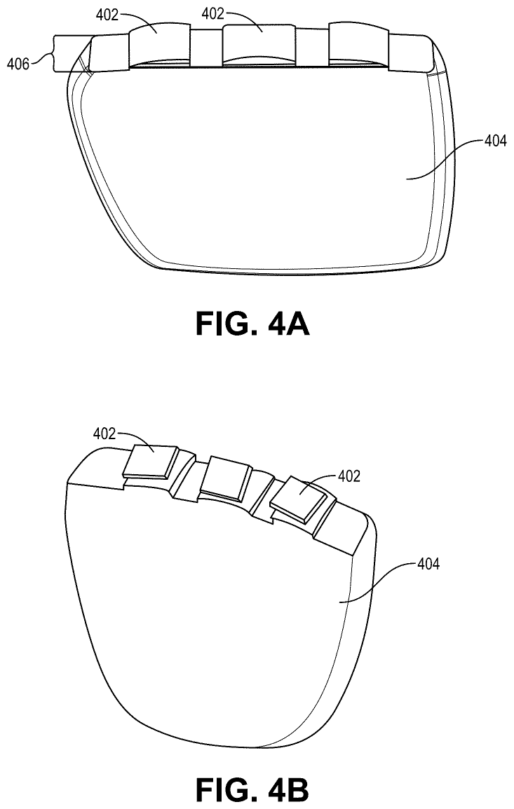

The QPIs used in the NEAR Display System comprise an array of micro-scale self-emissive pixels; i.e., not the reflective or transmissive type that require external light source, with typical pixel size ranging from 5-10 micron. Since, as explained earlier and as illustrated in FIGS. 4A and 4B, in the NEAR Display System multiple QPIs 402 are optically coupled onto the edge of the system relay and magnification optics (glasses lens) 404, one dimension 406 of the QPI is kept at the typical thickness of the NEAR display glasses lens, typically in the range of 4 mm. In addition, the QPI pixel array reaches the edge of the device to maintain “Zero-Edge” protrusion beyond the NEAR Display glasses lens edge thickness. Thus, with these two design methods, the multiple QPIs are maintained within the edge envelope of the NEAR Display System relay and magnification optics (glasses lens). With these two design methods, the QPI pixel array dimension across the NEAR Display System relay and magnification optics (glasses lens) thickness may be mapped onto the vertical FOV axis and when the QPI size is in the range 5-10 micron, the vertical FOV axis display spans approximately 400-800 pixels.

When multiple of such QPIs optically are coupled onto the edge of the system relay and magnification optics (glasses lens) each with 6.5-7 mm pixel array dimension along the lateral perimeter glasses lens, each such QPI lateral dimension provides 650-700 pixels along the horizontal FOV axis of the NEAR Display System. Thus, for example with one QPI having 3.6×6.4 mm pixel array dimension and 5 micron pixel size coupled on the topside of its optics glasses lens, the NEAR Display System pixel array resolution of (720×1280) pixel is achieved with 720 pixel and 1280 pixel along the vertical and horizontal axes; respectively, of each eye, which is an HD-720 resolution for each eye. When two QPIs each having 3.6×6.4 mm pixel array dimension and 5 micron pixel size coupled on the top bottom sides of its optics glasses lens, the NEAR Display System pixel array resolution of (1440×2560) pixel is achieved with 1440 pixel and 2560 pixel along the vertical and horizontal axes; respectively, of each eye, which is wide quad high definition (WQHD) resolution for each eye. It should be noted that in both of these two design examples, the multiple QPIs are optically coupled onto the edge of the system relay and magnification optics (glasses lens) having a thickness of approximately 3.6 mm. It should also be noted that in both examples, the NEAR Display System pixel resolution is achieved without blocking the display optical aperture, thus achieving maximum see-through optical aperture efficiency.

The QPI pixels are individually addressable to modulate the color and brightness of the light they emit across a programmable color gamut that extends at least 120% beyond the HD standard gamut. The QPI individual pixels' light emission gamut is “dynamic” is the sense that it can be programmed (or varied) dynamically at each video frame epoch. Furthermore, the QPI can modulate high order basis with dimensions ranging from (1×1) to (8×8) pixels with the dimensions of the modulation basis varying spatially and temporally across the QPI optical aperture. These two capabilities of the QPI allow the multiplicity of QPIs used in the NEAR Display system, as explained in the preceding example, to modulate a light field that closely matches its viewer's HVS spatial, color, and temporal acuity limits while operating power efficiently using compressed data input. This means that the NEAR Display System QPIs can adjust: (1) their light modulation color gamut to match that of the input video frame gamut, thus operate with an input of less than the conventional 8-bit per color per pixel in order to modulate the exact color gamut content of the input video frame; (2) the order of their spatial light modulation basis to dimensions, ranging from (1×1) to (8×8) pixels, to match the spatial density of the viewer's eyes' retinas' photo receptors' (rods and cones) density depending on the position of the viewer's eyes' fovea position as extracted from the viewer's detected or predicted pupils' position; and (3) the order of their spatial light modulation basis to dimensions, ranging from (1×1) to (8×8) pixels, based the compressed data, for example MPEG, basis of the frame video input.

The later method is referred to herein as “Visual Decompression” and primarily makes use of the temporal integration capabilities, or time constant, of the viewer's retina photo receptors. Furthermore, these three methods of a QPIs' dynamic adaptation to the NEAR Display System viewer's HVS acuity are also adjusted depending upon the viewer's depth of focus as extracted from the detected or predicted IPD of the viewer's pupils. The aforementioned design methods of the NEAR Display System allow it to operate at the viewer's HVS acuity limits while meeting the volumetric, weight and power constraints paramount for achieving wearability.

Two types of compression methods may be implemented in the NEAR Display System: Visual Decompression and Light Field compression. Visual Decompression is in both the stereo vision mode as well as the Light Field mode and may be implemented on OST-3 and OST-4 product generations starting with the stereo vision capability; both require only the processing capabilities of the QPIs and the NEAR Display LFP. The Light Field Compression requires the processing capabilities of the NEAR Display System LFP 122 and the LF Host Processor 126. The functions of the LF Host Processor hardware may be implemented on a remote processor with the earlier versions of OST-3 and OST-4 until F³ versions of these processors become available in the smartphone 314 of the NEAR Display System.

The Adaptation of the light field to the sensed ambient scene involves optical (color and brightness) blending and the addition of depth cues such as binocular disparity, ambient scene objects shadows and occlusion based on the extracted ambient scene objects parameters, ambient illumination scene shade variations based on the sensed ambient scene light distribution, linear perspective based on the extracted ambient scene objects parameters and texture gradient based on the viewer's detected (or predicted) focus depth. The software performing the Adaptation of the light field run on dedicated processor cores of the NEAR Display System LFP 122 and is integrated into the OST-3 and OST-4 product generations with an early versions running on an extra cQPI chip until the LFP becomes available and gets integrated into these product generations.

The Gaze/Pose Prediction function 124 make use of the viewer's eye and head position sensors 110, 114 output to update and propagate the HVS model in order to predict few frames ahead (up to 16 frames) the viewer's anticipated gaze direction and focus depth. The predicted gaze and focus depth values are used as input by the light field Acquisition function performed by LFP 122 to first update the current frame list of reference light field elements then initiate the Streaming Light Field (SLF) Protocol sequence (primitive) to request and acquire updated values of reference light field elements for the next frame. The software performing the Gaze/Pose Prediction function runs on dedicated processor cores of the NEAR Display System LFP 122 and is integrated into the OST-3 and OST-4 product generations with early versions running on an extra cQPI chip(s) until the LFP becomes available and gets integrated into these OST product generations.

The light field Rendering function performed by LFP122 decompresses the updated light field elements then constitutes (or synthesize) the updated light field for the next frame. The light field Rendering function software may run on dedicated processor cores of the LFP 122 and is integrated into the OST-3 and OST-4 product generations with early versions running on an extra cQPI chip until the NEAR LFP becomes available and gets integrated into these product generations.

The Gesture Sensor 136 and related software may be integrated into the OST-3 and OST-4 product generations first connected by wire then evolving to using wireless connectivity when such a connectivity function is integrated into these NEAR Display product generations. In earlier versions of the OST-3 and OST-4 product generations, Gesture Sensor output is relayed for processing by software running on an off-the-shelf dedicated processor chip, which may be the cQPI chip, until the LFP chip is used, where the associated processing cores are implemented and integrated into the higher version releases of OST-3 and OST-4 product generations.

Earlier released versions of Visual Decompression is integrated into the OST-3 and OST-4 product generations with its related software running on an extra cQPI chip.

The light field mode may be integrated into higher versions of the OST-3 and OST-4 product generations of the NEAR Display System with its related software first running on an emulated Host Processor LFP chip of a companion device for enabling the interface with other mobile devices such smartphone of Tablet PC then evolving to F³ higher versions integrated within the NEAR Display System volumetric envelope when of the LF Host Processor chip becomes available in mobile devices such smartphone of Tablet PC.

The Streaming Light Field (SLM) protocol and related compression algorithms software may be integrated into higher versions of the OST-3 and OST-4 product generations of the NEAR Display System first running on an emulated LF Host Processor chip of a companion device for enabling the interface with other mobile devices such smartphone of Tablet PC then evolving to F³ higher versions integrated within the NEAR Display System volumetric envelope when of the LF Host Processor chip becomes available in mobile devices such smartphone of Tablet PC.

The Connectivity function is integrated into the NEAR Display design starting with OST-2 product generation first using a connectivity companion device then ultimately integrated as off-the-shelf chips on the backplane of higher design versions of OST-3 and OST-4 product generations. These connectivity off-the-shelf chips perform the Wi-Fi and Bluetooth wireless interface and MHL wired interface to achieve connectivity with the NEAR Display prototypes MIPI backplane interface bus.

For test and verification of the Streaming Light Field (SLM) protocol, the Cloud Processor software is first implemented on an off-the-shelf processor connected to the Host processor using either wired or wireless interfaces to emulate the internet and wireless network interfaces. Together with the NEAR Display LFP and Host Processor, the Cloud Processor software implements the Streaming Light Field (SLM) protocol which may be developed and tested on the off-the-shelf development environment in parallel with the development of the NEAR display system series of designs when the various versions are ready for the integration with the respective capabilities.

The above described method of rolling NEAR Display System capabilities and feature set is purposely designed to respond to market demand, product market penetration and selling price point.

### 7. Physical Characteristics

Because of the described wearability design objective, as a mobile device, the NEAR Display System is constrained in both of its volumetric and power consumption characteristics. In comparison to a smartphone, the NEAR Display System is more constrained in these aspects in addition to having additional physical characteristics constraints on weight, design provisions for reducing scattered light interference and aesthetic appearance.

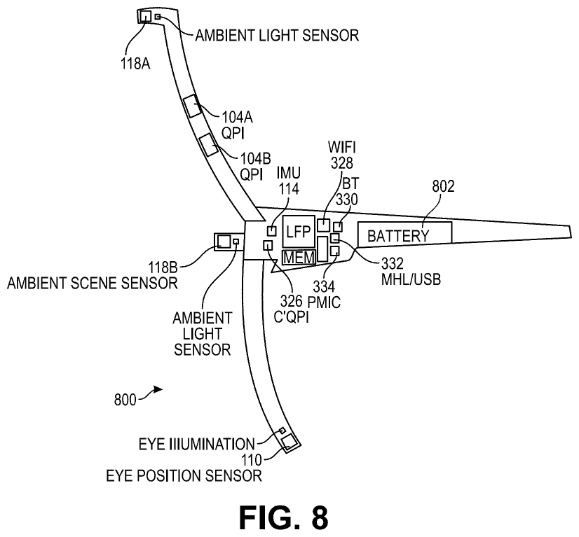

FIG. 8 shows an example layout 800 to fit the NEAR Display System in the volumetric constraints of a pair of sunglasses. The entire electronics layout area available in the example of FIG. 8 is less than 12 cm², including space for the battery 802, and the packaging thickness is also limited to less than 3 mm to make the entire electronics assembly fit within the wall thickness of a typical pair of sunglasses having less than 50 cc of total displacement volume. That makes the entire available packaging volume of the electronics to be about 3.6 cc, which is one order of magnitude smaller compared to the electronics package volume of a smartphone which is typically around 36 cc.

Although the NEAR display system design strategy is primarily aimed toward achieving such a challenging physical packaging constraint, advanced electronics systems packaging may be used. As explained earlier, the heavy lifting in terms of reducing the volumetric packaging requirements to a minimum is done at the QPI and LFP chip level which encapsulate close to 90% of the NEAR Display System processing functions. Advanced module level electronics packaging, such as System-in-a-Package (SIP), die-on-flex and 3-D electronics layout and direct encapsulation within the NEAR Display System glasses are used at the module level to complement nano-scale chip level integration of the QPI and LFP chips.

A challenge of power consumption efficiency is also significantly addressed in part by the nano-scale chip level integration of the QPI and LFP chips and at the system level by the NEAR Display System processing offload to the NEAR-PAN distributed computing environment. However, the battery 802 is a constraint on both the volumetric and power available design aspects. An energy storage efficiency that is much higher than what existing battery technology can now achieve is needed to address this challenge. The NEAR Display System design encompasses an innovation that is aimed directly at addressing this challenge by augmenting the battery with a Super Capacitor Integrated Circuit (SCIC) that together with the typically available small size mobile device battery can supply enough power to achieve the extended use objectives of the NEAR Display System while fitting in its constrained volume. SCIC is a new innovation that uses cost-effective semiconductor material and manufacturing technologies to create a very compact chip size high charge density super capacitor that efficiently complements an existing compact battery in multiple ways: first it increases the power available capacity of the entire system, second it increases the power storage efficiency of the entire system, and third it charges ultra fast—all being enhancements that not only make the NEAR Display System meet volumetric and extended use design goals but also may have an impact on the entire mobile power supply perspective and the power supply systems of other products. The SCIC being a semiconductor chip is volumetrically efficient and thin (less than 1mm) and as such can be efficiently encapsulated in any available space within the NEAR Display System. With the SCIC included, the power management function of the NEAR display system consists of the SCIC, the battery and the PMIC. The functionality of the PMIC may manage the power flow between the SCIC and the battery. With the SCIC being a part of the NEAR Display System, a Fast Charge mode may be added that allows the ability to fully charge the NEAR Display System in a short time (less than 5 minute and only limited by the charge power coupling interface efficiency). This capability contributes significantly to increasing the NEAR Display System wearability and mobility factors.

In summary the NEAR Display System meets challenging physical constraints through innovations at multiple levels; starting at the chip level with the power and volumetric efficiencies of the QPI and LFP chip, then at the module level with advanced system packaging and power system SCIC innovation and at the system level with the NEAR-PAN distributed computing environment.

### 8. Product

### Total System Solution Product

The NEAR display system product offering comprises the chips and software highlighted in FIG. 3 within the system context defined by the NEAR Display successive product versions capabilities described in Section 6. In this product offering, which is referred to as “Total System Solution”, the NEAR Display product design is licensed as intellectual property (IP) to the ultimate Value-Add customers to offer to consumers. Examples of such Value-Add customers that would benefit from the NEAR display system Total System Solution include smartphone original equipment manufacturers (OEMs), mobile content providers and the emerging Apps suppliers seeking an AR/VR display platform for their product offering. In the NEAR display system Total System Solution, NEAR Display product design is transitioned to the ultimate customer to transition the product to full scale manufacturing then sell it under the customer's own band name with NEAR Display chips; i.e., the QPIs and LFP chip sets, and related software highlighted in FIG. 3 being the product offering of the NEAR display system technology developer and supplier. The main intellectual property (IP) product offering is the NEAR Display System design with supporting IP product offering for the NEAR-PAN capable smartphone and smart watch designs. All three IP product offerings may be sold to the same ultimate customer while it would be also possible that any one customer that specializes in one product type would be more interested in the IP product offering of that product. For example, a customer with a strong brand name in the mobile device market may be interested in selling a NEAR capable smartphone or smartwatch while a customer with a strong brand name in the mobile content market may be interested in selling NEAR Displays to complement their content offerings. In all cases the NEAR display system technology developer and supplier works with the customer to transition the licensed IP product to manufacturing then subsequently sell the related NEAR display system chips & software to the customer over the lifetime of their product.

In the case of the NEAR display system IP product offering for the smartphone, the NEAR display system technology developer and supplier product offering could be either the selling of LF Host Processor IC to the customer or the selling of hard or soft IP Cores of the LF Host Processor for the customer to integrate with their next generation AR/VR capable GPU chip. The customer in this case could be the actual smartphone OEM or smartphone IC supplier having either a significant mobile GPU market share or a significant mobile IC offering to bundle with the NEAR display system capable GPU. This product offering also includes a license to the NEAR display system LF Host Processor embedded software which would be on-line upgradable to activate or upgrade the LF Host Processor operating features.

In the case of the NEAR display system IP product offering for the smart watch, the NEAR display system technology developer and supplier product offering involves selling the DeepSense sensor and license related software to customers engaged in selling the smart watch. The DeepSense software can execute on the smart watch main CPU or can execute on its own processor core that the NEAR display system technology developer and supplier offer as a hard or soft IP Cores for the customer to integrate with their main CPU. This product offering also includes a license to the Deep Sense software which would be on-line upgradable to activate or upgrade the sensor operating features.

There are some modifications to both BT and Wi-Fi protocol stack software that the NEAR display system technology developer and supplier provide as an integral part of the NEAR display system IP product offering for both the NEAR capable smartphone and smart watch. In actuality such protocol stack software modifications are more of an operating command script that tailors the connectivity of these wireless interfaces to the NEAR-PAN node connectivity.

The main anchor NEAR display system product offering is the NEAR Display for which the Total System Solution offering includes working closely with the customer to transition the multiple aspects of the NEAR Display to full scale manufacturing then selling the NEAR Display chipset (QPI, c′QPI and LFP) to the customer on recurring basis. This product offering also includes a license to the NEAR Display embedded software which may be on-line upgradable to activate or upgrade the NEAR Display operating features. Also over the lifetime of the customer's product, the NEAR display system technology developer and supplier product offering includes engaging the customers with NEAR Display generation upgrades in order to maintain the customers' market position.

The NEAR display system product offering to content providers has multiple aspects empowered by the high feature set of the NEAR Display and the high wearability and mobility factors it offers. Within the distributed computing environment of the NEAR display system mobile, Apps that leverages the NEAR Display high feature set typically run on the smartphone Mobile Application Processor (MAP) and interfaces locally with the LF Host Processor software to control and augment the content being routed to the NEAR Display and also interface with a reciprocating software agent executing on the NEAR display system LF Cloud Processor. One aspect of the NEAR display system technology developer and supplier product offering is the mobile environment API for the Apps to interface with the NEAR Display and LF Host Processor. Another aspect of the NEAR display system technology developer and supplier product offering is the cloud environment API for the Apps to interface with the LF Cloud Processor. Both of these aspects of the NEAR display system product offering aim to promote the NEAR Display and System vision with content and Apps developers and providers to ultimately make it the industry preferred operating platform standard. The upside for the content providers from the NEAR display system product offering is the enablement of their content products to be viewed through the high feature set light field visual experience of the NEAR display system. The upside for the NEAR display system technology developer and supplier from the NEAR display system product offering to content providers is the In-App and In-Use charges tallied by the LF Cloud Processor when mobile users view the contents enabled by high feature set of the NEAR display system.

As outlined above one important feature of NEAR display system product offering is that it spans multiple tiers of the mobile market. This is possible because of the depth and diverse innovations behind the NEAR Display System and its associated Total System Solution plus its underlying strategy to introduce an optimized system solution that achieves the ultimate vision of AR/VR displays becoming the “Next Big Thing”. This strategy recognizes that the current market separation and imbalance between hardware and software technologies and product innovations will not lead the industry toward achieving the grand vision sought-after by all of the market participants. The fact of the matter is that the old strategy of separation between hardware and software technologies and products that led to and worked well for the previous big things; i.e., the PC, cell phone and smartphone, will not work going forward mainly because of the vast imbalance it now suffers from. In the product innovations that will build and sustain the future of the mobile market the separation between hardware and software will blur as the two elements of the system are developed, integrated and sold as a seamlessly unified system optimized end to end to serve the overall mission of the future mobile products that inevitably are becoming distributed computing systems of networked nodes. Accordingly in the NEAR display system product offering there is no separation between hardware and software as the overall system product offering uses the well proven and familiar “Customer Subscription” model that helped in propelling the mobile digital media market to its current high gear growth.

Another important aspect of the NEAR display system product offering strategy is its built-in diversity in encompassing both hardware and software elements that span multiple tiers of the overall mobile echo system. In that regards, as explained earlier, the NEAR display system technology developer and supplier achieves revenue from OEMs selling the NEAR Display, the smartphone and smart watch that incorporate NEAR display system components as well as subscription revenue alongside with content providers who evolve their content product offering to the NEAR display system capabilities. In the first arm of this diverse strategy the NEAR display system technology developer and supplier work with OEMs to seed the mobile market with devices that incorporate the NEAR display system components and in the second arm of the strategy the NEAR display system technology developer and supplier work with content providers to proliferate contents enabled by the exceptional visual features that the NEAR display system offers to the mobile users. This strategy also deliberately leverages the current smartphone strong market base to evolutionally introduce the NEAR display system visual experience into the market in a way that overcomes the market entry barriers of customers' acceptance in both usability and affordability in order achieve strong mobile market penetration.

### Early Generation Product Offering

Several market dynamics are at play on the way to realizing the NEAR display system vision; some of the most relevant are the mobile market adoption and the availability of content. Given the recent market interest in AR/VR displays, several content providers are already working on the development of content in anticipation for the coming of viable products that will be able to achieve adequate level of mobile market adoption. As stated earlier, market adoption will likely be strongly dependent first on the mobile user's acceptance of the AR/VR displays mobility factor, physical characteristics and aesthetic appearance then second on the availability of content. The strategies of currently available AR/VR displays, such as Facebook Oculus and Microsoft Hololens and the like, is to focus first on specialty niche market segments such as games and commercial users. The problem with these types of strategies is that such specialty market segments are neither valid benchmarks nor true access points to the mobile user market, which is the ultimate market segment having the size and potential for making AR/VR displays become the “Next Big Thing”. Thus an innovative mobile market access strategy, that matches the NEAR display system innovative design and product market access methods described in the preceding discussion, is needed to complement the host of innovations the NEAR display system offers.

Pursuant to that goal, the described NEAR display system product offering includes an evolutionary path from the current mobile display toward the ultimate visual experience to be offered by the NEAR Display. With this mobile market access strategy the actual mobile users acquire an early generation NEAR Display that readily interfaces and work with their existing smartphone to allow mobile users to enjoy the visual experience offered by the NEAR Display within the context of existing smartphone mobile services, content and Apps. The main objective with this mobile market access strategy is to gain the mobile users acceptance of the NEAR Display first within their familiar mobile environment then systematically introduce NEAR display system advanced features as the market evolves and commensurate content become available.

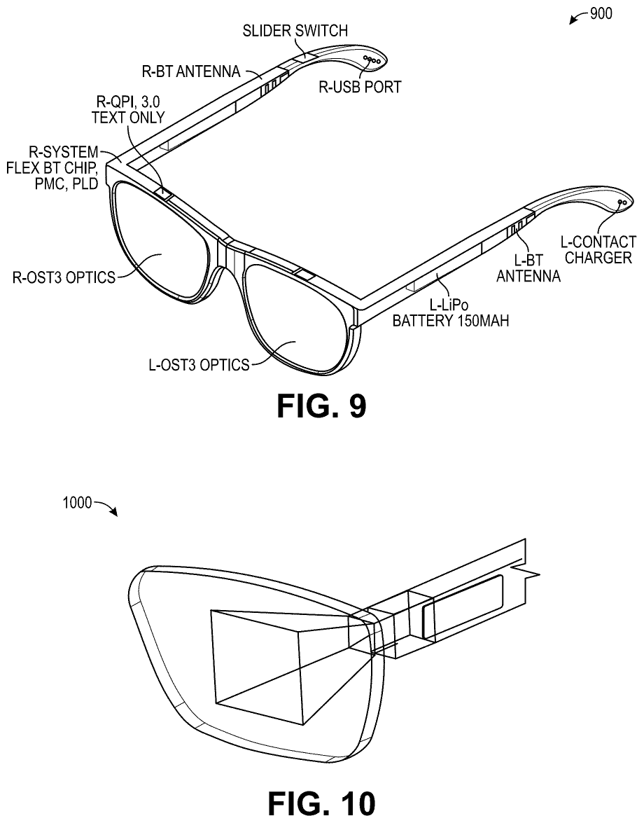

FIG. 9 shows a design concept of the NEAR Display early generation 900, herein referred to as NEAR-EG. The NEAR-EG Display design meets all of the critical design goals of size, weight, extended use and streamline look needed for acceptance by the mobile users and requires no adjunct components to be added into the smartphone, smart watch or the cloud to avoid their associated long design-in cycle. One aspect of this strategy is to make it rather easy for the mobile users, deciding on their own initiative, to acquire a NEAR Display to use with their existing smartphone to view their favorite content using this latest advancement in display technology, which is most definitely a much needed level of mobile user excitement especially given the stalemate of current smartphone technology. Another aspect of this strategy is that it is readily possible for smartphone OEMs as well as content providers to gain confidence in the level and progress of mobile market penetration to pace their level of market engagement, which in turn will help push the NEAR display system overall vision into a reality.

The NEAR-EG Display 900 illustrated in FIG. 9 may use the QPI and OST-3 optics complemented by off-the-shelf components to introduce a NEAR Display product that can be ready for market deployment within a short time period. The ideal customer to partner with for this NEAR Display early generation is either a smartphone OEM aiming to leapfrog the competition in the mobile AR/VR market or a content provider interested in gaining a leadership position the mobile AR/VR market. In both cases the NEAR display system technology developer and supplier NEAR-EG Display partner will be self-motivated with the upside of their own product offering as complemented by the NEAR-EG feature set and ability for early market penetration.

### 9. Matching the Human Visual System Acuity Limits:

9.1 Matching HVS Field of View, Spatial, Color, Depth and Temporal Acuities

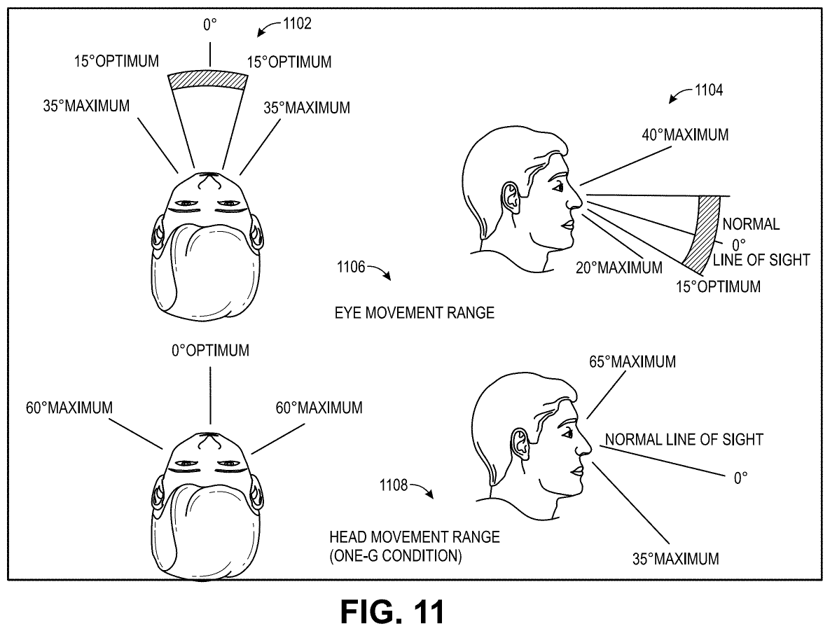

In order to put the specified capabilities of the NEAR Display System in perspective, it is important to place it within the context of the ranges, capabilities and limitations of the HVS 102. FIG. 11 shows the eye and head movement ranges in terms of the azimuth 1102 and elevation ranges 1104 on the left side and right side of FIG. 11, respectively, with eye movement 1106 and head movement 1108 on the upper and lower side of FIG. 11, respectively.

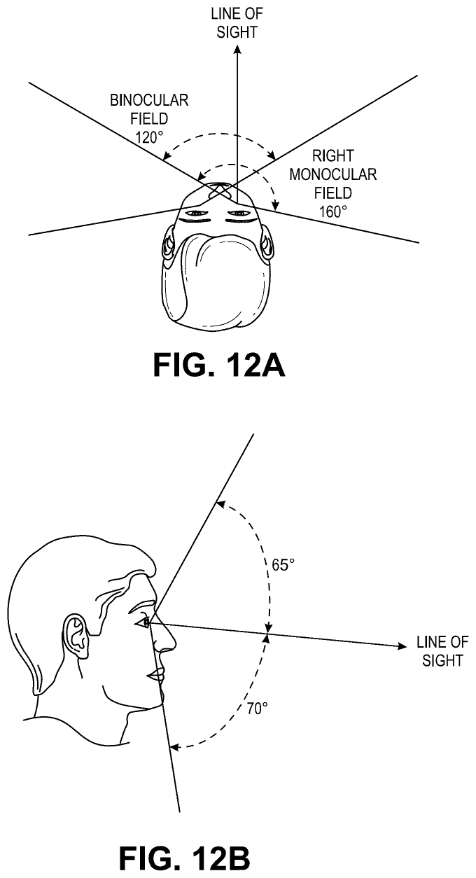

Taking into account the optical field of view (FOV) of the viewer's individual eyes combined with the eye movements shown in FIG. 11, the approximate FOV of an individual human eye (measured from the fixation point, i.e., the point at which the viewer's gaze is directed) is 60° nasal (towards the nose), and 100-110° temporal (away from the nose and towards the temple), 60° superior (up), 70°-75° inferior (down). This combined FOV of the HVS is illustrated in FIGS. 12A and 12B. The combined visual FOV for both eyes is approximately 200° in azimuth (or horizontal) as shown in FIG. 12A and 130°-135° in elevation (or vertical) as shown in FIG. 12B. Also shown in FIG. 12A is the horizontal overlap of the monocular FOV of each of the viewer's eyes, which extends approximately 160° from the nasal to the temporal sides of each eye, to create approximately 120° of binocular vision FOV from the viewer's two eyes. It should also be noted that the viewer's binocular vision extends only within a limited range of depth surrounding where the viewer is focused.

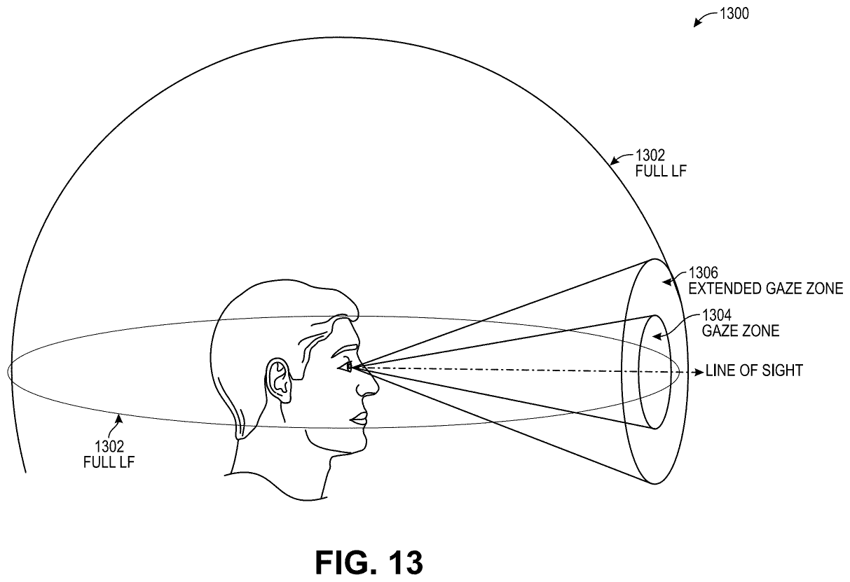

When the viewer's head movement range illustrated in FIG. 11 is taken into account, the HVS range of FOV extends even further than the range shown in FIGS. 13A and 13B. In actuality the viewer's visual range beyond the HVS range extends even further when the viewer's body movement is also taken into account. In the described NEAR Display System design architecture, as illustrated at 1300 in FIG. 13, the viewer's eyes, head and body movements are sensed and tracked to the extent that it is possible to provide the viewer with 360° surround light field visual experience while addressing and actually modulating only a small fraction of that extended visual range at any instant of time. This is an important feature of the NEAR Display System of matching the HVS capabilities and limits that make it possible to meet the challenging NEAR Display physical design constraints described earlier.

It should be noted, however, the described HVS FOV ranges are the full available extent of these ranges including eye, head and body movements while in fact the instantaneous HVS FOV, in terms of its light sensing capabilities, is ultimately defined (or limited by) by the eye optical properties and the retina photoreceptors resolution, density distribution and temporal sensing properties as complemented by the cognitive perception properties the HVS visual cortex. Perception occurs when the neurons in the HVS visual cortex “fire” action potential when visual stimuli appear within their corresponding receptive sensory region of the retina. The visual cortex vernal pathway, often called the “what” pathway, is responsible for recognition perception and is associated with the long-term visual memory. The dorsal pathway of the visual cortex neurons, which is often called the “where” pathway, is responsible for perception of motion of objects of interest and the corresponding control of the eyes movements, as well as head and arms movements, and to guide eye movements (saccades) and head movements used to acquire and track objects of interest and arms movements used for reaching (or touching) objectors of interest. Thus, in the HVS cognitive perception process, the dorsal and vernal pathways of the visual cortex work together in a feedback loop that tracks and acquires to place an object of interest into the fovea region of the retina, then cognitively recognize objects of interest within the HVS FOV at its highest possible acuity level. Of course, such a feedback loop has a response time constant which is typically in the range 150-250 ms.

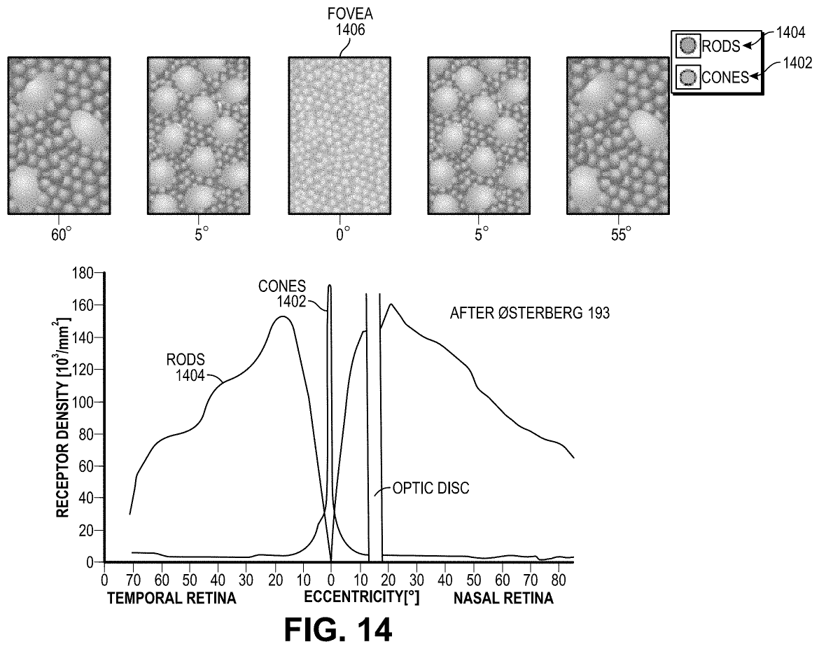

In order to further appreciate these HVS matching features of the NEAR Display System it's also useful to put in perspective the combination of the HVS FOV summarized above and the sensory visual (ocular) capabilities of the HVS. This is important because the HVS matching features of the NEAR Display System achieves its advantages, as explained earlier, by only modulating light input to the HVS that would be cognitively perceived by the viewer's HVS—that way the NEAR Display System achieves the highest possible efficiency in managing its resources. To that extent the capability of the human eye retina is a key factor as it defines what of the light modulated by the NEAR Display System would at first order be detected. FIG. 14 shows the human eye retina photo receptors (cones 1402 which are sensitive to color light and rods 1404 which are sensitive only to brightness) angular density distribution centered from the fovea 1406. Besides the change in eye photoreceptors density across the angular range of the retina, the retina color perception also changes across the visual field. The retina color sensitivity is dominated by the cones and is best at the central region of the fovea and declines, rather rapidly, away from the fovea center, in the periphery as the retina photoreceptor density becomes dominated by rods. Sensitivity to red-green color variations declines more steeply toward the periphery than sensitivity to luminance or blue-yellow colors.

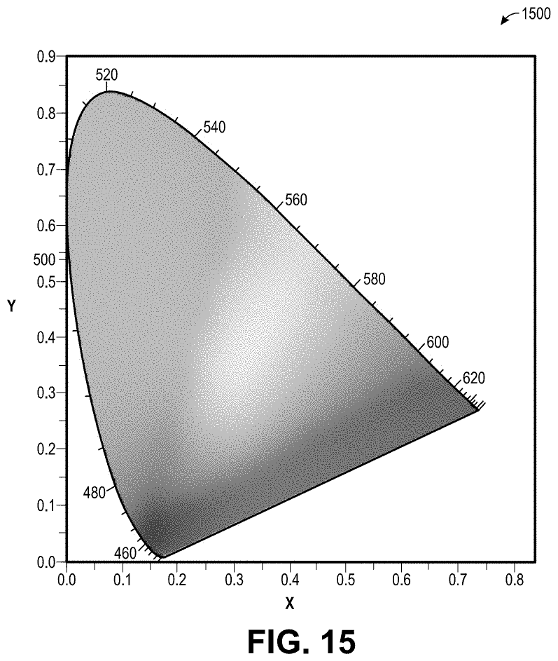

Although as shown in FIG. 14, the retina cone density peaks to in excess of 147,000 mm⁻² at the center of the fovea, the retina cone density drops dramatically to about 75,000 mm⁻² at 130 μ and reaching about 6,000 mm⁻² at 1 mm from the center of the fovea. As a result the foveola, which is the central 1.7° region of the fovea that is responsible for the highest human visual acuity, has only about 30,000 cones for sensing all three colors and no rods. At the foveola cones density the angle subtended by each cone is about 31.5 arc sec, which is the light cone generated by a pixel size of about 40 μ positioned at 25 cm—the estimated HVS “Near Field Distance” known as the closest distance at which a healthy naked human eye can focus. Thus the foveola achieves the highest HVS spatial acuity in being able to resolve nominally one line pair subtending about 1 arc min. It is worth noting that the QPI with 5-10 micron pixel size can pack 16-64 pixels, respectively, within the HVS Near Field highest spatial acuity limit, a capability that is critical for light field modulation because it mean that the QPI can modulate 16-64 view hogel at the HVS highest acuity level—which is deemed more than sufficient for near-eye light field applications. However, the HVS spatial acuity decreases dramatically from its highest value across the retina reaching ½ at 130 μ (0.5°) to 1/24 at 1 mm)(3.5°) from the center of the fovea. Since the retina cones are responsible of color sensitivity, the HVS color acuity exhibits a corresponding distribution across the retina with the highest color acuity of the full photopic color gamut 1500 shown in FIG. 15 at the foveola with systematically decreasing gamut size as the cone density decreases and the rod density increases toward the peripheral region of the retina. Since the retina rods are sensitive only to light intensity, effectively the HVS color acuity systematically reduces to the white point of the photopic color gamut 1500 shown in FIG. 15 toward the peripheral region of the retina. Another effect of the described HVS spatial acuity distribution across the retina is that objects in focus at HVS “Near Field Distance” are resolved at higher spatial acuity resolution than objects in focus at the HVS “Far Field Distance”, beyond 2.5 m from the eye, thus producing the perception of higher level of details, or texture, of nearer objects. This near/far coloration between the HVS focus depth and the focused object's texture contributes to the HVS depth acuity (see following discussion on HVS Depth Cues).

The purpose of the eye movements range shown in FIG. 11, therefore, is to keep the portion of the total FOV the viewer is focused on within the highest visual acuity region of the retina; namely, the fovea in general and the approximately 1.7°˜2° central region of it, the foveola in particular. The viewer's eyes move to maximize the monocular vision acuity and the head moves to minimize the difference in monocular acuity critical for binocular vision. As a result the image that is perceived by the HVS is basically an overlay of the viewer's eye visual FOV centered around the viewer's gaze direction and the photo sensory response distribution of the retina shown in FIG. 13 around that axis—also known as the fixation axis. With that effect what is perceived by the viewer around the fixation axis is a zone of the visual FOV that is modulated by the HVS spatial, color and depth acuities distributions whereby at the central part of that zone, namely, the foveola 1.7°˜2° region, these acuities are at their highest levels then decreases systematically, and somewhat rather fast, toward the peripheral regions of the visual FOV.

The angular range from the HVS Near Field to Far Field spans a range of about 7.5° (of the nasal side) that is typically covered mainly by eye movements to allow rapid accommodation within the visual FOV. The eye movements within that range include saccades, which are rapid, simultaneous movements of both eyes (in the same direction) which serve to bring the visual target at the fovea where the visual acuities are maximum. This is necessary for vergence accommodation of having both eyes pointing towards and focused on the same visual target to enable maximum visual resolution of the visual target. Even while the eyes are fixated at a focus target, microsaccades eye movements at a rate of 2-3/sec and an angular range of 0.02°-0.3° ensure the eye photoreceptors (cones and rods) are continually stimulated to maintain their visual sensory output. Beyond the eye movement that cover the Near/Far Fields while the head is fixed, reflex eye movement stabilize images on or near the foveola 1.7°˜2° region of the retina during head or target movement by producing corresponding eye movement.

Eye movements are controlled by several oculomotor neural subsystems (dorsal pathway) of the visual cortex, each processing different aspects of sensory stimuli, and producing eye movements with different temporal profiles and reaction times. As explained earlier, the HVS visual acuity is high for images that fall on the fovea, where the density of photoreceptors is greatest, but poor for images that fall on peripheral regions of the retina. ‘Gaze-shifting’, which includes the saccadic, pursuit and vergence oculomotor neural subsystems, enables high-spatial-frequency sampling of the visual environment by controlling the direction of the foveal projections of the two eyes. The saccadic subsystem processes information about the distance and direction of a target image from the current position of gaze, and generates high-velocity movements (saccades) of both eyes that bring the image of the target onto or near the fovea. The typical reaction time of the oculomotor neural subsystem controlling the saccadic movements is about 200 ms and generates eye movements at velocity in the range 400-800 deg/sec. The pursuit subsystem uses information about the speed of a moving object to produce eye movements of comparable speed, thereby keeping the image of the target object on or near the fovea. The typical reaction time of the oculomotor neural subsystem controlling pursuit movements is about 125 ms and generates movements at velocity in the range 0-30 deg/sec if the target motion is unpredictable but could be faster if it occurs in conjunction with other type of eye movements. Using information about the location of a target in depth, the vergence subsystem controls the movements of the eyes that bring the image of the target object onto the foveal regions of both eyes. The typical reaction time of the oculomotor neural subsystem controlling the vergence movements is about 160 ms and generates eye movements at velocity in the range 30-150 deg/sec but could be faster if it occurs in conjunction with other type of eye movements. Visual acuity also depends on the speed of image motion across the retina: ‘image slip’ must be low for acuity to continue to be high during object tracking.

The oculomotor ‘gaze-holding’ subsystems compensate for head and body movements that would otherwise produce large shifts of the images of stationary objects across the retina. Vestibular signals, related to rotation or translation of the head or body, mediate the compensatory eye movements of the Vestibulo-Ocular Reflexes (VOR). Visual signals about the speed and direction of full-field image motion across the retina initiate optokinetic reflexes that supplement the VOR in the low-frequency range. In effect, therefore, the eye movements encode the reactions generated by the oculomotor neural subsystems of the visual cortex in response to the visual environment stimuli that occurred some 125-200 ms (˜7.5-20 display image input frames at 60-Hz rate) earlier. Thus (detecting) the viewer's eye, head and body movements (provides) encodes a rich information metric that could be used to reveal, or predict few frames ahead, how the HVS would nominally respond to stimuli from its visual environment while simultaneously also providing localization information of objects within HVS visual environment. As described earlier, one of the most important HVS matching aspects of the NEAR Display System is that makes use of this property of the HVS by sensing the viewers eye and head positions and processing the sensed information by NEAR Display Gaze/Pose Predication functional element to predict ahead (approximately 200 ms) what portion of the light field to acquire (fetch using LFS protocol), and accordingly encode and modulate the acquired visual data into the highest acuity region of the viewers eyes at the highest possible fidelity by adapting the NEAR Display QPIs light modulation parameters to match the viewer's HVS spatial, color, temporal and depth acuities across the retina while also compressing the modulating visual information in order to minimize its power consumption. In effect, therefore, the NEAR Display System minimizes the use of its resources by matching the viewer's HVS visual cortex dorsal and vernal pathways feedback loop time constant, a capability that is made possible by the compressed input capabilities of its light modulation QPIs as well as its unique feature of including the HVS in-the-loop by modeling the oculomotor neural subsystem parameters based on the sensed eye and head movements the using the oculomotor neural subsystem parameters to predict ahead viewer's gaze vector in time to acquire the gaze zone information and adapt the QPI' s to match the HVS acuity around predicted gaze vector in time with the viewer's corresponding eye and head movements.

The described design of the NEAR Display System modulates its light field output to match the overlay of HVS visual acuity by first predicting the viewer's gaze direction then by matching its resolution to viewer's HVS photo sensory response (or acuity) distribution around the predicted gaze direction. The NEAR Display System predicts the viewer's gaze direction and focus depth then matches its light modulation output accordingly to the HVS acuity not just tracks the gaze direction only as in conventional near-eye displays. In addition, the NEAR Display System uses detecting the viewer's eye, head and body movements information to localize objects within the HVS visual environment. These features of the NEAR Display System minimize the response latency, which typically plagues conventional near-eye display systems that relies on only tracking the viewer's gaze direction, in addition to maximizing the efficiency in utilizing the NEAR Display System resources.

### NEAR Display System Gaze/Pose Prediction Method

The Gaze/Pose Prediction functional element 124 of the NEAR Display System 100 sequentially computes discrete-time estimates a set of states representing the HVS visual cortex (oculomotor neural subsystem) dorsal pathway nerves action potential (or nerve stimulants) to the set of extraocular, ciliary and iris muscles that control the movements and focus action of the viewer's eyes using an observation vector comprised of the sensed (x,y) position, iris diameters and interpupillary distance (IPD) of the viewer's eyes. The estimates of the HVS visual cortex dorsal pathway nerves states are based on sequential discrete-time updates of a variance-covariance matrix of these states using nonlinear sequential estimation methods such as Kalman Filter, for example, based on the discrete-time sensed values of the HVS observation vector. The discrete-time updated viewer's HVS visual cortex dorsal pathway nerves states variance-covariance model is propagated forward in time (125-250 ms) to compute estimated discrete-time predictions the viewer's eyes gaze/pose vector and focus depth. The computed Gaze/Pose predictions are used as prompts (or cues) for fetching and processing, in advance, the visual information the HVS is attempting (or intending) to acquire as indicated by the sensed eye and head movements plus IPD. With every discrete-time iteration of the Gaze/Pose predictions process the estimates of the set of states representing the HVS visual cortex dorsal pathway nerves action potential are updated as the estimation model becomes continuously refined in terms of its accuracy in predicting the viewer's Gaze/Pose parameters. Since the model dorsal pathway nerves action potential also control the viewer's arms movements, for reaching objects of interest, the estimated dorsal pathway nerves action potential is also used to provide cues, or predictions, of the viewer's expected gesture zone, thus enabling the NEAR Display System to refine its estimate of the viewer's gesture and interaction with the displayed light field.

### Cognitive Visual Memory Compression

Eye movements also encode information on human cognition in that it reveals prior knowledge of objects within the HVS environment. This effect, which is referred to as ‘Visual Memory’, is manifested by decreased eye saccades rate and angular magnitude when the viewer recognizes a familiar object. Keeping track of the viewer's eye movement statistics would, therefore, offer another dimension of Visual Compression of objects already present in the viewer's visual memory. Leveraging the HVS visual memory recalls as indicated by eye movements the NEAR Display System modulates a less articulated (or more abbreviated) light field visual output, using its visual compression and dynamic gamut capabilities, to match the detected eye saccades rate and angular magnitude statistics representing the viewer's visual memory recall cues. In this design method the NEAR Display System takes advantage of the visual cortex vernal pathway object recognition and long term visual memory capabilities to further compress the input to the light modulation QPIs, as explained earlier with regard to the visual decompression encoding functional element of the NEAR Display System, and achieve further efficiency in total system power consumption.

As explained earlier, the NEAR Display System has the capabilities to extract and map the parameters of objects present in the viewer visual environment. Correlating extracted and mapped objects database content with detected visual memory recall cues, the NEAR Display System identifies and keeps track of a subset of reference images of objects, faces, icons and/or marker that frequently appeared within the displayed content that triggered visual memory recall cues then using its visual compression and dynamic gamut capabilities to subsequently abbreviate the fine details of the displayed images of such reference images in order to reduce processing, memory, and interface bandwidth and thus also realize additional savings in power consumption. This feature is another way that the NEAR Display System leverages the long term cognitive visual memory perceptional capabilities of the human visual system (HVS). In effect the NEAR Display System takes advantage of the fact that the HVS virtually fills in the details from its short and long term visual memory required to recognize and/or identify familiar or previously visually sensed objects and images in order to maximize the overall NEAR Display System efficiency, in terms of response latency, processing throughput, memory requirements and power consumption.

FIG. 13 shows the multi-tier approach of the NEAR Display System having a Gaze Zone 1304, an Extended Gaze Zone 1306 and a Full Light Field 1302. The Gaze Zone 1304 is centered around the viewer's current gaze axis and its full angular extent is ±7.5° defined the double-sided angular range between the Near Field and the Far Field. In the center 2° of the Gaze Zone 1304, the NEAR Display System modulates a fully articulated light field to match the high acuity of the viewer's fovea region (see FIG. 13 line representing retina cone density). The resolution and color gamut modulated by the NEAR Display System is systematically reduced outward from the center 2° again to match the acuity distribution of the viewer's eye retina to match the corresponding retinal acuity distributions. The NEAR Display System progressively expands the center 2° of Gaze Zone toward the predicted gaze direction as the viewer responds to the visual environment. The NEAR Display System uses Visual Compression, Dynamic Gamut, Light Field Compression and Compressed Foveated 3D Rendering to adapt its effective modulation resolution, gamut size and depth distribution across the Gaze Zone to match the acuity distribution of the viewer's HVS. In so doing the NEAR Display System realizes a substantial level of processing, memory and data interface bandwidth reductions especially at the near-eye node of the system; i.e.; the NEAR Display element, in addition to introducing a rich set of depth cues that enable an exceptional Light Field visual experience in the mobile environment.

In order to present the viewer with a surround Light Field viewing experience the NEAR Display System first progressively extends the matching of the HVS acuity outward through the full extent of its optical FOV which is designated in FIG. 13 as the Extended Gaze Zone 1306, then uses the detected viewer's head and body movements to present the viewer with the commensurate segments of the Full Light Field 1302. In effect the visual experience of the viewer of the NEAR Display System is a visual presence inside a streaming 360° surround LF that seamlessly and indistinguishably blends into the viewer's physical reality. The described multi-tier aspects of the NEAR Display System architecture corresponds with Gaze Zone 1304, Extended Gaze Zone 1306 and Full Light Field 1302 illustrated in FIG. 13.

9.2 Matching HVS Depth Cues

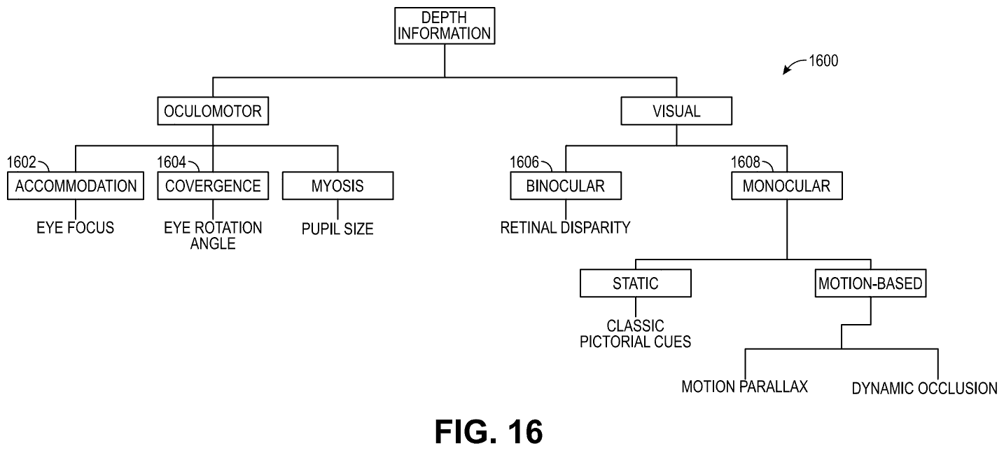

The HVS relies on several cues to achieve depth acuity. FIG. 16 outlines at 1600 some of the HVS depth cues into oculomotor and visual cues which are more fully summarized below. Many of these depth cues are embedded within the light field presented to the viewer by the NEAR Display System. In blending the light field it displays with the viewer's physical reality, the NEAR Display System adds several visual environment depth cues, such as real/virtual occlusion, shades and shadows, that further enhance the viewer's depth perception and contribute to the goal of achieving the viewer's sensation of being inside a unified light field physical and augmented reality.
1. Accommodation 1602—Depth of focus as indicated by eye lens muscle tension. Effective within 2 meter focus distance. Contributes to both monocular and binocular depth sensing.
2. Convergence 1604—Difference in eyes' directions as indicated by eyes' socket muscles tension. Effective within 10 meter focus distance.
3. Binocular Parallax (Disparity) 1606—Difference between retinal images sensed by the two eyes. Strongest depth cue. Most effective for medium viewing distances.
4. Monocular Movement Parallax (Disparity) 1608—Temporal image difference. Extracting depth from sequentially sensed images. Contributes to sensing depth with head movements.
5. Retinal Image Size (not shown)—Coverage of image on eye retina (related to foveal resolution) as related to objects known size.
6. Linear Perspective (not shown)—Convergence of parallel lines with distance and relative size of object with depth.
7. Texture Gradient (not shown)—Resolution of image texture (related to foveal resolution). Sensing more details of objects at closer distance used to sense depth.
8. Occlusion (not shown)—Overlapping of imaged objects. Closer objects overlap farther objects.
9. Aerial Perspective (not shown)—Haziness or fuzziness of far away objects sensed as depth.
10. Shades & Shadows (not shown)—Casted shadows of objects and shades of illumination gives a sense of depth.

1. A wearable display system comprising:
an optical lens element, an electronic display device, an eye position sensor, a head position sensor, gaze/head pose prediction means, an image or light field processor, and, a host processor configured to input and output data from the system to a Cloud processor.
